(19) United States
(12) Patent Application Publication
(10) Pub. No.: US 2024/0411296 A1
(43) Pub. Date: Dec. 12, 2024

(54) COMPUTER IMPLEMENTED METHOD FOR THE DETECTION AND CLASSIFICATION OF ANOMALIES IN AN IMAGING DATASET OF A WAFER, AND SYSTEMS MAKING USE OF SUCH METHODS

(71) Applicant: Carl Zeiss SMT GmbH, Oberkochen (DE)

(72) Inventors: Thomas Korb, Schwäbisch Gmünd (DE); Philipp Huethwohl, Ulm (DE); Jens Timo Neumann, Aalen (DE); Abhilash Srikantha, Neu-Ulm (DE)

(21) Appl. No.: 18/781,256

(22) Filed: Jul. 23, 2024

Related U.S. Application Data
(63) Continuation of application No. PCT/EP2023/050921, filed on Jan. 17, 2023.

(30) Foreign Application Priority Data
Jan. 27, 2022 (DE) 10 2022 101 884.9

(51) Int. Cl. G05B 19/418

(52) U.S. Cl. CPC G05B 19/41875; G05B 2219/32368

(57) ABSTRACT

A computer implemented method detects and classifies anomalies in an imaging dataset of a wafer comprising a plurality of semiconductor structures. The method comprises determining a current detection of a plurality of anomalies in the imaging dataset, and obtaining an unsupervised or semi-supervised clustering of the current detection of the plurality of anomalies. Based on at least one decision criterion at least one cluster of the clustering is selected for presentation and annotation to a user via a user interface. An anomaly classification algorithm is re-trained based on the annotated anomalies. A system for controlling the quality of wafers and a system for controlling the production of wafers are also disclosed.

### CROSS-REFERENCE TO RELATED APPLICATIONS

The present application is a continuation of, and claims benefit under 35 USC 120 to, international application No. PCT/EP2023/050921, filed Jan. 17, 2023, which claims benefit under 35 USC 119 of German Application No. 10 2022 101 884.9, filed Jan. 27, 2022. The entire disclosure of each of these applications is incorporated by reference herein.

### FIELD

The disclosure relates to a computer implemented method for detecting and classifying anomalies in an imaging dataset of a wafer comprising a plurality of semiconductor structures. The disclosure also relates to a system for controlling the production of wafers in a semiconductor manufacturing fab, and to a system for controlling the quality of wafers produced in a semiconductor manufacturing fab.

### BACKGROUND

Semiconductor manufacturing generally involves precise manipulation, e.g., etching, of materials such as silicon or oxide at very fine scales in the range of nm. A wafer is a thin slice of semiconductor used for the fabrication of integrated circuits. Such a wafer serves as the substrate for microelectronic devices containing semiconductor structures built in and upon the wafer. It is constructed layer by layer using repeated processing steps that involve gases, chemicals, solvents and the use of ultraviolet light.

As this process is complicated and highly non-linear, optimization of production process parameters can be difficult. As a remedy, an iteration scheme called process window qualification (PWQ) can be applied. In each iteration a test wafer is manufactured based on the currently best process parameters, with different dies of the wafer being exposed to different manufacturing conditions. By detecting and analyzing the defects in the different dies based on a quality control, the best manufacturing process parameters can be selected. In this way, production process parameters can be tweaked towards optimization.

The detected defects are, thus, used for root cause analysis and serve as feedback to improve the process parameters of the manufacturing process, e.g., exposure time, focus variation, etc. For example, bridge defects can indicate insufficient etching, line breaks can indicate excessive etching, consistently occurring defects can indicate a defective mask and missing structures hint at non-ideal material deposition etc.

With process parameters slowly approaching optimization, a highly accurate quality control process for detecting and classifying defects on wafer surfaces can be desirable.

Conventionally, quality control of wafers can rely on the identification of areas of interest via low resolution optical tools such as bright field inspection tools followed by a high-resolution review via scanning electron microscopy (SEM). Inspection of such SEM images is usually done manually or using a classical pattern recognition algorithm with manually designed annotations. Such processes can exhibit one or more of the following: only defects visible at the lower resolution are detected and analyzed; the process are resource intensive, since two different imaging modalities are used for inspection; and the process uses can have long turnaround times. Inspection can be limited to a small portion of the wafer. This can lead to unreliable quality control results. Especially when production parameters approach optimality, results of high quality are generally indispensable.

Current technologies such as multibeam scanning electron microscopy (mSEM) can overcome image large regions of a wafer surface with high resolution in a short period of time. To this end, mSEM uses multiple single beams in parallel, each beam covering a separate portion of a surface, with pixel sizes down to 2 nm. Yet, the resulting datasets can be huge and generally cannot be analyzed manually.

Methods for the automatic detection of defects include anomaly detection algorithms, which are often based on a die-to-die or die-to-database principle. The die-to-die principle compares portions of a wafer with other portions of the same wafer thereby discovering deviations from the typical or average wafer design. The die-to-database principle compares portions of a wafer with ideal simulated data from a database, e.g., a CAD file of the wafer, thereby discovering deviations from the ideal data. Unexpected patterns in the imaging dataset are detected due to large differences and are subsequently analyzed to derive classification criteria, e.g., thresholds, area coverage, aspect ratio, etc. Such anomaly detection algorithms can be sensitive to the underlying SEM simulation and, thus, can be hard to generalize to new sample types.

In addition, not all anomalies are defects. For instance, anomalies can also include, e.g., imaging artefacts, image acquisition noise, varying imaging conditions, variations of the semiconductor structures within the norm, rare semiconductor structures or variations due to imperfect lithography, varying manufacturing conditions or varying wafer treatment, etc. Such anomalies that are not defects but detected by some anomaly detection method are referred to as nuisance in the following.

Even for machine learning algorithms, such datasets can pose challenges, since they are highly imbalanced. This can mean that almost all of the data contains correct semiconductor structures, whereas defects are extremely rare.

Anomaly detection methods applied to imaging datasets of wafers can, therefore, have a very high nuisance rate n, which is the inverse of the precision rate p, i.e., n=1μp, since far too many and mostly irrelevant deviations on wafer surfaces are discovered. Consequently, an anomaly detection algorithm uses extensive post-processing to be useful for defect detection on wafer surfaces.

In order to discriminate between real defects and nuisance, an annotator would review huge portions of the dataset to find sufficient defect samples for successfully training a machine learning algorithm. In general, this is hardly feasible due to the large annotation effort. In order to manage the labeling effort for the annotation of large datasets, active learning has been applied.

Such an active learning system for the classification of anomalies was disclosed in the U.S. Pat. No. 11,138,507 B2. Here, in a preliminary initialization step, an unsupervised clustering algorithm is applied to a given plurality of defects in a specimen. Then a user assigns labels to the clusters thereby determining the set of class labels and a preliminary classification of the defects. Based on this preliminary classification the classifier is initially trained before applying the active learning stage. The active learning stage comprises repeatedly presenting to the user a single sample associated to one of the classes with a low likelihood together with samples of high likelihood of the same class in order to obtain a decision from the user if the sample belongs to the associated class, followed by retraining the classifier. However, the set of class labels is fixed during the initialization, so no further labels can be added. And since only a single sample is presented to the user during the active learning stage the user effort for annotation can be high.

Another active learning system for training a defect classifier is described in US 2019/0370955 A1. Various sampling strategies are employed to identify current least information regions (CLIRS), from which new samples are drawn for presentation to the user. The defect catalogue can be extended to unknown labels.

An active learning system for classification of images has been proposed in the article “K. Wang, D. Zhang, Y. Li, R. Zhang and L. Lin, Cost-Effective Active Learning for Deep Image Classification, in IEEE Transactions on Circuits and Systems for Video Technology, vol. 27, no. 12, pp. 2591-2600, 2017”. A special sample selection strategy based on uncertain samples as well as high confidence samples is used to obtain high classification accuracy at low annotation cost.

An active learning system for wafer map pattern classification has been proposed in the article “J. Shim, S. Kang and S. Cho, Active Learning of Convolutional Neural Network for Cost-Effective Wafer Map Pattern Classification, in IEEE Transactions on Semiconductor Manufacturing, vol. 33, no. 2, pp. 258-266, May 2020”.

Yet, all of these approaches can involve the challenge that cold-starting the workflow is not feasible. Cold-starting relates to a common issue in machine learning systems involving automated data modelling. Specifically, it concerns the issue that the system cannot draw any inferences for users or items about which it has not yet gathered sufficient information. This frequently occurs in the semiconductor industry, since production processes and wafer types are constantly adapted and, thus, the machine learning algorithms have to be trained again from scratch.

With the above approaches, cold-starting is generally not feasible, since 1) the approaches involve extensive use of prior knowledge such as the location of the defects to be classified or a known catalogue of all defects occurring on the wafer surface, 2) despite the application of active learning still a large amount of annotated data samples is used for cold-starting, and 3) the user effort for labeling samples is high. These are generally not met in realistic scenarios, where neither the location of the defects on the wafer nor the defect types are known beforehand and labeling time of expert users is very expensive.

### SUMMARY

The disclosure seeks to resolve high-precision defect detection and classification in an imaging dataset of a wafer, which makes cold-starting feasible.

In an aspect, the disclosure provides a computer implemented method for the detection and classification of anomalies in an imaging dataset of a wafer, comprising a plurality of semiconductor structures. The method comprises: selecting a machine learning anomaly classification algorithm followed by at least one outer iteration comprising the following steps: determining a current detection of a plurality of anomalies in the imaging dataset, obtaining an unsupervised or semi-supervised clustering of the current detection of the plurality of anomalies and executing multiple inner iterations. At least some of the inner iterations comprise the following steps: the anomaly classification algorithm is used to determine a current classification of the plurality of anomalies in the imaging dataset. Based on at least one decision criterion at least one anomaly of the current detection of the plurality of anomalies is selected by selecting at least one cluster of the clustering for presentation to a user via a user interface, the user interface being configured to let the user assign one or more class labels of a current set of classes to each of the at least one cluster. The anomaly classification algorithm is re-trained based on anomalies annotated by the user in an inner iteration of the current or any previous outer iteration.

The disclosure also relates to one or more machine-readable hardware storage devices comprising instructions that are executable by one or more processing devices to perform operations comprising one of the methods disclosed herein.

In an aspect, the system for controlling the quality of a wafer produced in a semiconductor manufacturing fab comprises the following features: an imaging device adapted to provide an imaging dataset of the wafer, a graphical user interface configured to present data to the user and obtain input data from the user, one or more processing devices, one or more machine-readable hardware storage devices comprising instructions that are executable by one or more processing devices to perform operations comprising one of the methods disclosed herein comprising assessing the quality of the wafer based on the one or more measurements and at least one quality assessment rule.

In an aspect, the system for controlling the production of wafers in a semiconductor manufacturing fab comprises the following features: mechanism for producing wafers controlled by at least one manufacturing process parameter, an imaging device adapted to provide an imaging dataset of the wafer, a graphical user interface configured to present data to the user and obtain input data from the user, one or more processing devices, one or more machine-readable hardware storage devices comprising instructions that are executable by one or more processing devices to perform operations comprising a method comprising controlling at least one wafer manufacturing process parameter based on the one or more measurements.

The disclosure involves the idea of integrating anomaly detection, anomaly classification and active learning within a single workflow in order to simultaneously minimize the desired prior knowledge and the annotation effort for the user while still achieving results of high precision (i.e., low nuisance rates). In this way, reduced demands are placed on the user in terms of prior knowledge and/or annotation effort, which makes cold-starting feasible without loss of precision. Such methods can be used in systems for controlling the production and/or quality of wafers in a semiconductor manufacturing fab.

The disclosed methods cam combine anomaly detection and anomaly classification in the outer iterations, while the inner iterations implement an active learning system for the training of the anomaly classification algorithm. Active learning can be implemented by selecting at least one anomaly for presentation to the user based on a decision criterion, e.g., grouping anomalies based on a similarity measure between them. The combination of anomaly detection, anomaly classification and active learning within a single workflow can mean that the combination of an anomaly detection followed by a subsequent classification of the anomalies makes low nuisance rates possible. Typically, an anomaly detection will yield anomalies in the imaging dataset that include both defects and nuisance. Based on the defect classification algorithm, it is possible to discriminate defects from nuisance by defining defect classes along with one or more nuisance classes. Furthermore, it is possible to accurately classify the type of defect. In this way, the workflow can be trained to detect and classify only relevant defects while nuisance can be suppressed.

Further, the combination can allow the user to modify the anomaly detection algorithm and/or the anomaly classification algorithm during training cycles, thus tuning both algorithms simultaneously based on the current anomaly detection and classification results.

Moreover, all previously labeled training samples can still be used for the training of the anomaly classification algorithm despite modifications in one of the algorithms. In this way, the training of the anomaly classification algorithm can be carried out most effectively keeping annotation effort and annotation time at a low level. Furthermore, cold-starting becomes possible, since training can begin based on a reduced dataset, which is later on expanded to include different sections of the imaging dataset containing other defects.

In addition, the additional integration of active learning into the workflow can minimize user interaction by reducing annotation effort for the user. The decision criterion ensures that the most informative anomalies are selected for presentation to the user. In this way, a small number of annotations is sufficient to obtain a classification of high accuracy. By concurrently presenting multiple anomalies, e.g. in the form of one or more clusters, to the user the annotation effort is further reduced. Thus, an extension of the imaging dataset during cold-starting becomes feasible without using a lot of annotation effort of the user. Important design considerations thereby are to minimize repeated actions of the user, to direct all expert-driven decisions to a few points within the workflow, to minimize waiting times for the user between inputs and to enable the expert to infer the rationale behind the decisions of the automated system.

The human effort is particularly reduced as a result of reviewing and classifying a large number of detections into defects or nuisance, by grouping detections for human annotation and by directing the human to rare cases. Therefore, edge-cases can be identified quickly and thoroughly resulting in defect detection methods that are robust to real world conditions while exhibiting low nuisance rates. In addition, the workflow meets the desired properties of the semiconductor industry, where large datasets are to be processed and associated defects analyzed and visualized including scenarios, where no prior knowledge of underlying defects is available, i.e., cold-starting.

In general, the performance of the workflow can be measured in terms of performance metrics based on the following variables:

TABLE 1
variables used to measure the performance of a machine learning
algorithm, the first column contains the variable, the second
column its definition, the third column contains the corresponding
amounts for the anomaly detection algorithm, the fourth column
contains the corresponding amounts for the anomaly classification
algorithm or, respectively, the whole workflow.

| | | | Anomaly classification/ |
|---|---|---|---|
| | Definition | Anomaly detection | Workflow |
| tₚ | true positives | detected anomalies | defects classified as defect |
| fₚ | false positives | detected non- | nuisance classified as defect |
| | | anomalies | |
| tₙ | true negatives | undetected non- | nuisance classified as |
| | | anomalies | nuisance |
| fₙ | false negatives | undetected | defects classified as |
| | | anomalies | nuisance |

Based on these variables the following performance metrics can be defined:

TABLE 2
performance metrics for machine learning algorithms in general and for
defect detection and classification, based on the variables in Table 1.

| Performance metric | Definition |
|---|---|
| Precision | $p := \frac{{t}_{p}}{{t}_{p} + {f}_{p}}$ |
| Nuisance rate | $n := 1 - p = \frac{{f}_{p}}{{t}_{p} + {f}_{p}}$ |
| Capture rate / recall rate | $c := \frac{{t}_{p}}{{t}_{p} + {f}_{n}}$ |

The performance metrics can be computed for the anomaly detection algorithm, for the anomaly classification algorithm or for the whole workflow.

The precision rate of the anomaly detection algorithm indicates the ratio of the correctly detected anomalies (true positives) with respect to all detections (true positives plus false positives). The nuisance rate of the anomaly detection algorithm refers to the inverse of the precision rate, i.e., 1−p. The capture rate of the anomaly detection algorithm indicates the ratio of the correctly captured anomalies (true positives) with respect to all anomalies (true positives plus false negatives).

The precision rate of the anomaly classification algorithm indicates the ratio of the defects classified as defect (true positives) with respect to all defect classifications (true positives plus false positives). The nuisance rate of the anomaly classification algorithm refers to the inverse of the precision rate, i.e., 1−p. The capture rate of the anomaly classification algorithm indicates the ratio of the defects classified as defect (true positives) with respect to all defects (true positives plus false negatives).

The precision rate of the whole workflow indicates the ratio of the defects detected and classified as defect (true positives) with respect to all defect classifications (true positives plus false positives). The nuisance rate of the whole workflow refers to the inverse of the precision rate, i.e., 1−p. The capture rate of the whole workflow indicates the ratio of the defects detected and classified as defect (true positives) with respect to all defects in the dataset (true positives plus false negatives).

The disclosure aims at achieving a high capture rate along with a low nuisance rate (or high precision rate) of the workflow. Ideally all defects in the imaging dataset are recognized, while at the same time all recognitions pertain to defects.

An anomaly can generally pertain to a localized deviation of the imaging dataset from an a priori defined norm. A defect can generally pertain to a deviation of a semiconductor structure or another imaged sample from an a priori defined norm of the structure or sample. For instance, a defect of a semiconductor structure could result in malfunctioning of an associated semiconductor device.

The imaging dataset can, e.g., pertain to a wafer including a plurality of semiconductor structures. Other information content is possible, e.g., in imaging dataset including biological samples, e.g., tissue samples, optical devices such as glasses, mirrors, etc., to give just a few examples. Hereinafter, various examples will be described in the context of an imaging dataset that includes a wafer including a plurality of semiconductor structures, but similar techniques may be readily applied to other use cases.

According to the techniques described herein, various imaging modalities may be used to acquire an imaging dataset for detection and classification of defects. Along with the various imaging modalities, it would be possible to obtain different imaging data sets. For instance, it would be possible that the imaging dataset includes 2-D images. Here, it would be possible to employ mSEM. mSEM employs multiple beams to acquire contemporaneously images in multiple fields of view. For instance, a number of not less than 50 beams could be used or even not less than 90 beams. Each beam covers a separate portion of a surface of the wafer. Thereby, a large imaging dataset is acquired within a short duration of time. Typically, 4.5 gigapixels are acquired per second. For illustration, one square centimeter of a wafer can be imaged with 2 nm pixel size leading to 25 terapixel of data. Other examples for imaging data sets including 2D images would relate to imaging modalities such as optical imaging, phase-contrast imaging, x-ray imaging, etc. It would also be possible that the imaging dataset is a volumetric 3-D dataset, which can be processed slice-by-slice or as a three-dimensional volume. Here, a crossbeam imaging device including a focused-ion beam (FIB) source and a SEM could be used. Multimodal imaging datasets may be used, e.g., a combination of x-ray imaging and SEM.

Machine learning is a field of artificial intelligence. Machine learning algorithms generally build a parametric machine learning model based on training data consisting of a large number of samples. After training, the algorithm is able to generalize the knowledge gained from the training data to new previously unencountered samples, thereby making predictions for new data. There are many machine learning algorithms, e.g., linear regression k-means or neural networks.

A machine learning model is the output of a machine learning algorithm run on training data. The model represents what was learned by the machine learning algorithm. It comprises both model data and a prediction algorithm. The model data contains rules, numbers or any other algorithm-specific data structures used to make predictions for new data samples. The prediction algorithm is a procedure indicating how to use the model data to make predictions on new data. For example, the decision tree algorithm results in a model comprised of a tree of if-then statements with specific values. The neural network algorithms (e.g., backpropagation or gradient descent) result in a model comprised of a graph structure with vectors or matrices of weights with specific values. The application of a machine learning algorithm to data means the application of the prediction algorithm based on the trained model to the new data.

Deep learning is a class of machine learning that uses artificial neural networks with numerous hidden layers between the input layer and the output layer. Due to this extensive internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Active learning is a paradigm in the field of machine learning in which a learning algorithm can interactively query a user to label new data points. Since the algorithm can choose data points which are most informative for its progress, learning can be organized in a very effective way.

A device includes a processor. The processor can load and execute program code. Upon loading and executing the program code, the processor performs a method, for example one of the methods disclosed herein.

In the disclosed method, multiple outer iterations can be executed, at least some of them comprising the steps i. of determining a current detection of a plurality of anomalies in the imaging dataset, ii. of obtaining an unsupervised or semi-supervised clustering of the current detection of the plurality of anomalies and iii. of executing multiple inner iterations.

In the context of this disclosure, the term “multiple” means at least two. Executing multiple outer iterations allows the user to not only modify the training data for the anomaly classification algorithm, but also to go back and modify previous stages such as the determination of the current detection of the plurality of anomalies. Because of the integration of both, anomaly detection and classification, the user can visualize and directly react to the current classification results of the workflow by modifying exactly the stage which they desire to have improved. Due to this increased flexibility and transparency of the workflow classification results of higher quality can be obtained within a short period of time.

The current detection of the plurality of anomalies in the imaging dataset can be determined via hand annotation by a user. Apart from that, computer implemented algorithms can be used for this task, e.g., pattern matching algorithms, segmentation algorithms or machine learning algorithms.

The current detection of the plurality of anomalies in the imaging dataset can be determined for a subset of the imaging dataset or for the whole of the imaging dataset. In this way, cold-starting can be realized by determining a current detection of anomalies for a small subset of the imaging dataset in a first outer iteration and increasing the subset of the imaging dataset and the current detection of anomalies during subsequent outer iterations.

Determining a current detection of a plurality of anomalies in the imaging dataset can comprise the following steps: selecting a machine learning anomaly detection algorithm; training the anomaly detection algorithm; determining a current detection of a plurality of anomalies in the imaging dataset. The step of training the anomaly detection algorithm is optional. The step of selecting a machine learning anomaly detection algorithm can, for example, comprise selecting a pre-trained anomaly detection algorithm. In a subsequent outer iteration, the step of selecting an anomaly detection algorithm can, for example, comprise modifying the parameters of the anomaly detection algorithm, or re-training the anomaly detection algorithm using different training data, or applying the anomaly detection algorithm to a different subset of the imaging dataset, or selecting a different kind of anomaly detection algorithm (e.g., selecting a deep learning algorithm instead of a support vector machine or a segmentation algorithm). This approach can mean that the detection of anomalies can be determined automatically and with no or little effort by the user. A machine learning anomaly detection algorithm can be any algorithm which can be trained, e.g., a neural network, a support vector machine, a random forest, a decision tree, a regression model or a Bayes classifier.

The selected anomaly detection algorithm can be trained comprising the following steps: selecting training data for the anomaly detection algorithm, the training data containing at least one subset of the imaging dataset of the wafer and/or of an imaging dataset of at least one other wafer and/or of an imaging dataset of a wafer model; re-training the anomaly detection algorithm based on training data selected in the current or any previous outer iteration.

The training data can contain at least one subset of the imaging dataset itself. In this way the algorithm learns to discriminate between typical structures of the wafer and rarely occurring structures such as defects based on statistical principles about the frequency of the occurring structures. Apart from that, the training data can contain imaging datasets of at least one other wafer comprising further semiconductor structures which share one or more features with the semiconductor structures of the wafer depicted by the particular imaging dataset including anomalies to be classified. In this way, knowledge about typical structures and rare structures can be transferred from the other wafer to the current wafer.

Instead of using imaging datasets of real wafers, imaging datasets of wafer models can be used, e.g., CAD files of the wafer itself or of other wafers. In general, these wafer models contain no or only few defects. If a wafer model of the wafer itself is available, it can be used as reference for comparing regions of the imaging dataset with the corresponding regions of the imaging dataset of the wafer model. If wafer models of other wafers are available, these can be used to build knowledge about structures without defects via the machine learning algorithm. The knowledge can be used for detecting anomalies in the imaging dataset of the current wafer. The anomaly detection algorithm can then be trained based on training data selected in the current or any previous outer iteration.

The anomaly detection algorithm can be trained on the whole imaging dataset of the wafer. Alternatively, the user interface can be configured to let the user indicate one or more interest-regions in the imaging dataset, and the training data for the anomaly detection algorithm is selected only based on these interest-regions. This approach enables cold-starting of the system, since the user can start with a small interest-region and train the workflow quickly based on a small number of anomalies and a subset of the defects occurring on the wafer surface. During further iterations of the workflow the user can expand the interest-regions and re-train the system to include further defects or anomalies. This enables the user to iteratively train the workflow encompassing the entire dataset with minimal effort. In this way, the method can be quickly brought to a practicable level, where it can be applied to new datasets.

The user interface can be configured to let the user define one or more exclusion-regions in the imaging dataset in order to exclude portions of the imaging dataset from being selected as training data. The training data for the anomaly detection algorithm then does not contain data based on these exclusion-regions. These exclusion-regions can for example comprise regions, which are irrelevant for the defect analysis or regions, which have been selected as training data in previous iterations. In this way, annotation effort is reduced for the user.

The method could additionally comprise automatically suggesting new interest-regions and/or new exclusion-regions based on at least one selection criterion, e.g., a similarity measure between the already selected interest-regions and further sections of the imaging dataset, and presenting the new interest-regions and/or exclusion-regions to the user via a user interface. The user could, for example, select a border or a die region. Then, based on a similarity measure between different regions of the imaging dataset of a wafer, further border or die regions could be proposed. The user could then select one, several or all of them to add these to the interest-regions and/or exclusion-regions. In this way, the annotation effort for the user can be reduced.

A tile of the imaging dataset contains an anomaly and a surrounding of the anomaly. In general, tiles (e.g., 2-D images or 3-D voxel arrays) extracted from the imaging dataset and input to the anomaly detection algorithm can include a sufficient spatial context of the anomaly to be detected. Respective tiles should be at least as large as the expected anomaly, but also incorporate a spatial neighborhood context.

The anomaly detection algorithm can comprise an autoencoder neural network. The plurality of anomalies can be detected based on a comparison between an input tile of the imaging dataset and a reconstructed representation thereof obtained by presenting the tile to the autoencoder neural network. An autoencoder neural network is a type of artificial neural network used in unsupervised learning to learn efficient codings of unlabeled data. An autoencoder comprises two main parts: an encoder that maps the input into a code, and a decoder that maps the code to a reconstruction of the input. The encoder neural network and the decoder neural network can be trained so as to minimize a difference between the reconstructed representation of the input data and the input data itself. The code typically is a representation of the input data with lower dimensionality and can, thus, be viewed as a compressed version of the input data. For this reason, autoencoders are forced to reconstruct the input approximately, preserving only the most relevant aspects of the data in the reconstruction.

Therefore, autoencoders can be used for the detection of anomalies. Anomalies generally concern rare deviations from the norm within an imaging dataset. Due to the rarity of their occurrence the autoencoder will not reconstruct this kind of information, thus suppressing anomalies in the imaging dataset. Anomalies can then be detected by comparing the imperfect reconstruction of a tile (containing the anomaly and optionally its surroundings) to the original imaging data of the tile. The larger the difference between them, the more likely an anomaly is contained in the tile. The decision if an anomaly is present can be taken based on one or more thresholds of the difference image of the tile. Further measurements can also be used for this decision, e.g., the size, location or shape of the differences or their local distribution.

According to an example, the user interface is configured to present multiple anomalies of the current detection of the plurality of anomalies to the user, to let the user select one or more of the presented multiple anomalies and to let the user assign one or more class labels of a current set of classes to the selected anomalies. In this way, the user can select a subset of the presented anomalies for annotation, for example a subset which is well suited for annotation.

One of the at least one decision criterion can be formulated with regard to the current classification of the plurality of anomalies in the imaging dataset.

Each anomaly can be associated with a feature vector, and the decision criterion is formulated with regard to the feature vectors associated with the plurality of anomalies. This allows using a representation of the anomalies (instead of the anomalies themselves), which is more suitable for selecting anomalies by the decision criterion. For example, distances can be computed between feature vectors in vector spaces Also, additional or enhanced information about the anomalies could be coded in the feature vectors. If the anomalies are represented by feature vectors, the similarity or dissimilarity measures used to formulate the decision criterion can be applied to the feature vectors of the respective anomalies instead.

The feature vector associated with an anomaly could, for example, comprise the raw imaging data of the anomaly or of a tile containing the anomaly. The feature vector associated with an anomaly could also comprise the pre-processed imaging data of the anomaly or of a tile containing the anomaly, e.g., structural features such as a histogram of oriented gradients (HoG), a scale invariant feature transform (SIFT) or a stack of filter responses, e.g., of Gabor filters, etc.

The feature vector associated with an anomaly can comprise the activation of a layer, such as the penultimate layer, of a pre-trained neural network when presented with the anomaly as input.

In machine learning, especially in deep learning, the activation of a layer of a neural network can be viewed as a feature vector. This is because the layers generally perform convolution and pooling operations, thereby extracting low-level and high-level features from the input data. Especially deep neural networks learn significant high-level features in their numerous hidden layers. The activation of the penultimate layer, i.e., the second last layer, is especially suited as feature vector since the information is most abstracted from the original input data presented to the network, and since the final output of the network is finally calculated based on the activation of the penultimate layer. For example, the VGG16 convolutional neural network for classification and detection can be used. VGG16 is a widely used Convolutional Neural Network architecture developed by the Visual Geometry Group of the University of Oxford.

In general, the neural network used for obtaining the feature vector can be pre-trained on a set of images, for example the VGG16 network can be pretrained on the ImageNet dataset.

Using the activation of a layer of a neural network as feature vector in the decision criterion improves the selection of anomalies for presentation to the user to reduce the annotation effort. This is because the anomalies are selected by the decision criterion based on a set of highly informative features, which were learned from data instead of being designed by a user. This makes the features especially meaningful for the selection task.

In addition or alternatively, the feature vector associated with an anomaly could comprise a histogram of oriented gradients of the respective anomaly. Such HoG features contain structural information about an anomaly and its context by representing the directions of image gradients. Using such meaningful feature vectors in the decision criterion can be beneficial for the selection of similar anomalies. Due to the locality of the HoG features, the feature vectors are invariant to geometric and photometric transformations. Furthermore, the local histograms can be contrast-normalized to remove effects of variable imaging conditions.

Multiple anomalies can be simultaneously presented to the user. In his way, the user can annotate all of them at the same time. It is typically desirable to select the anomalies to be concurrently presented to the user so that there is a significant likelihood that a significant fraction of the anomalies concurrently presented to the user will be annotated with the same label. In this way, the annotation effort is reduced.

For this reason, the at least one decision criterion can comprise a similarity measure between the multiple anomalies. By selecting anomalies with a high similarity between each other for presentation to the user, the anomalies are likely to belong to the same anomaly class and, thus, can be classified with a single user interaction, thereby further reducing the annotation effort. In this way, repeated user interactions are also avoided and waiting times between user interactions is minimized.

The similarity measure can comprise a distance measure between two of the multiple anomalies. The larger the distance between two anomalies the lower is their similarity.

For example, let xᵢ and xⱼ denote two anomalies, then the following similarity measures could be used:

$$\begin{matrix}s ( {x}_{i} , {x}_{j} ) = cos ( {x}_{i} , {x}_{j} ) & Cosine similarity \\ s ( {x}_{i} , {x}_{j} ) = \frac{1}{1 + {d ( {x}_{i} , {x}_{j} )}^{k}} , k > 0 & Distance based similarity\end{matrix}$$

For a distance based similarity, the following distance measures could for example be used:

$$\begin{matrix}d ( {x}_{i} , {x}_{j} ) = {( {\sum }_{k = 1}^{p} {( {x}_{ik} - {x}_{jk} )}^{r} )}^{1 / r} , r > 0 & \begin{matrix}{L}_{r} - distance , \\ especially Euclidean distance ( r = 2 )\end{matrix} \\ \begin{matrix}d ( {x}_{i} {x}_{j} ) = \sqrt{{( {x}_{i} - {x}_{j} )}^{T} {S}^{- 1} ( {x}_{i} - {x}_{j} )} , \\ S = Cov ( {x}_{i} )\end{matrix} & \begin{matrix}Mahalanobis distance , \\ Cov ( {x}_{i} ) indicates the covariance \\ matrix of the vector {x}_{i}\end{matrix}\end{matrix}$$

The similarity measure can comprise the cosine function, which is 1 for identical feature vectors and 0 for maximally dissimilar feature vectors.

For measuring the similarity of a group X containing more than two anomalies, one of the following group similarity measures GS could, for example, be used:

$$\begin{matrix}GS ( X ) = median ( s ( {x}_{i} , {x}_{j} ) \vert {x}_{i} , {x}_{j} ∈ X , i < j ) & median \\ GS ( X ) = mean ( s ( {x}_{i} , {x}_{j} ) \vert {x}_{i} , {x}_{j} ∈ X , i < j ) & mean \\ GS ( X ) = min ( s ( {x}_{i} , {x}_{j} ) \vert {x}_{i} , {x}_{j} ∈ X , i < j ) & minimun \\ GS ( X ) = max ( s ( {x}_{i} , {x}_{j} ) \vert {x}_{i} , {x}_{j} ∈ X , i < j ) & maximum\end{matrix}$$

The decision criterion D for selecting a set of at least one anomaly X from the set of all current anomalies Y could then be implemented in one of the following ways:

$$\begin{matrix}D ( Y ) = \{ X ⊆ Y \vert GS ( X ) > T \} & The subsets X of selected anomalies \\ & have a group similarity measure GS ( X ) \\ & above a certain threshold T . \\ X = arg max \{ G S ( X ) \vert X ⊆ Y \} & The subsets X of selected anomalies \\ & have the highest group similarity \\ & measure GS ( X ) of all subsets X of Y .\end{matrix}$$

The one or more subsets X of anomalies selected based on the decision criterion are then presented to the user. If the similarity is computed based on feature vectors, the set of anomalies associated with the selected set of feature vectors can be presented to the user instead.

The at least one decision criterion can further comprise a similarity measure of the selected at least one anomaly and one or more further anomalies that were selected in an inner iteration of the current or any previous outer iteration. By selecting anomalies with a low similarity to one or more previously selected anomalies, the concept of group novelty can be implemented. This concept ensures that the selected training data is most dissimilar from previously selected training data. In this way, the variability of the training data is quickly explored, thereby reducing the time used for training of the anomaly classification algorithm and, thus, the user interactions. In addition, this can facilitate a steep learning curve of the machine learning algorithms to be trained.

For the computation of similarity measures between two different sets of anomalies, for example between a set A of selected anomalies for presentation to the user (e.g., a cluster) and a set B of previously presented anomalies (e.g., one or more previously presented clusters), a between group similarity measure BGS can be defined based on the similarity measures s indicated above, for example:

$$\begin{matrix}BGS ( A , B ) = median ( s ( a , b ) \vert a ∈ A , b ∈ B ) & Median \\ BGS ( A , B ) = mean ( s ( a , b ) \vert a ∈ A , b ∈ B ) & Mean \\ BGS ( A , B ) = min ( s ( a , b ) \vert a ∈ A , b ∈ B ) & Minimun \\ BGS ( A , B ) = max ( s ( a , b ) \vert a ∈ A , b ∈ B ) & Maximum\end{matrix}$$

For numerical reasons, it could be desirable to, instead, use a between group dissimilarity measure BGD to measure the dissimilarity between two different sets of anomalies, for example between a set A of selected anomalies (e.g., a cluster) for presentation to the user and a set B of previously presented anomalies (e.g., one or more previously presented clusters). The BGD can be computed based on the distances between anomalies by replacing the similarity measures by one of the distance measures d indicated above:

$$\begin{matrix}BGD ( A , B ) = median ( d ( a , b ) \vert a ∈ A , b ∈ B ) & Median \\ BGD ( A , B ) = mean ( d ( a , b ) \vert a ∈ A , b ∈ B ) & Mean \\ BGD ( A , B ) = min ( d ( a , b ) \vert a ∈ A , b ∈ B ) & Minimun \\ BGD ( A , B ) = max ( d ( a , b ) \vert a ∈ A , b ∈ B ) & Maximum\end{matrix}$$

Given a set of previously selected anomalies P, the decision criterion D for group novelty, that means for selecting a set of at least one anomaly X from the set of all current anomalies Y based on a low similarity (respectively high dissimilarity) to the set P, could then be implemented in one of the following ways:

| | |
|---|---|
| D(Y) = {X ⊆ Y\|BGS(X, P) < | The subsets X of anomalies selected via |
| T} | the decision criterion have a between |
| | group similarity measure BGS(X, P) |
| | below a certain threshold T with respect |
| | to the set of previously selected |
| | anomalies P. |
| D(Y) = {X ⊆ Y\|BGD(X, P) > | The subsets X of anomalies selected via |
| T} | the decision criterion have a between |
| | group dissimilarity measure BGD(X, P) |
| | above a certain threshold T with respect |
| | to the set of previously selected |
| | anomalies P. |
| X = argmin{BGS(X, P)\|X ⊆ | The subset X of anomalies selected via |
| Y} | the decision criterion have the lowest |
| | between group similarity measure |
| | BGS(X, P) of all subsets X of Y with |
| | respect to the set of previously selected |
| | anomalies P. |
| X = argmax{BGD(X, P)\|X ⊆ | The subset X of anomalies selected via |
| Y} | the decision criterion have the highest |
| | between group dissimilarity measure |
| | BGD(X, P) of all subsets X of Y with |
| | respect to the set of previously selected |
| | anomalies P. |

The one or more subsets X of anomalies selected based on the decision criterion are then presented to the user. If the similarity or dissimilarity is computed based on feature vectors, the set of anomalies associated with the selected set of feature vectors could be presented to the user instead.

It is understood that each similarity measure can also be used as a dissimilarity measure by using its inverse and vice versa.

Another implementation of the concept of group novelty could provide that the decision criterion comprises a probability of an anomaly for not belonging to the current set of classes. The decision criterion can, for example, comprise the median or average probability of a set of anomalies for not belonging to the current set of classes. This approach ensures a quick exploration of the variability of the dataset and a quick discovery of the set of classes used for classifying the current imaging dataset or interest-region. The probability of an anomaly for not belonging to the current set of classes can be understood as the probability of the anomaly for being an outlier with respect to the current set of classes. This probability can be computed by using an open set classifier as anomaly detection algorithm.

Let x ∈ X indicate an anomaly of a set of multiple anomalies X of the set of all anomalies Y, then an implementation of the decision criterion D could be the following:

$$D ( Y ) = arg max \{ f ( X ) \vert \{ X ⊆ Y \}$$

$$f ( X ) = median ( P ( x is an outlier w \cdot r \cdot t \cdot the current set of classes ) \vert x ∈ X \}$$

An implementation of the decision criterion could also comprise that the selected at least one anomaly is classified as a predefined class or a class from a predefined set of classes in the current classification. In this way, the user can limit the selection of the multiple anomalies for presentation to the user to specific classes, which the user is especially interested in or for which the predictions of the classifier have been of low accuracy so far. This approach renders the training of the classifier very flexible and, thus, reduces the time used for training together with the annotation effort of the user.

The at least one decision criterion could comprise the multiple anomalies selected for presentation to the user being classified as the same class in the current anomaly classification. In this way, the anomalies presented to the user are very likely to actually belong to the same class allowing the user to annotate the multiple anomalies based on a single of very few user interactions.

The at least one decision criterion can also comprise a population of the one or more classes the at least one anomaly is assigned to in the current classification. For instance, it would be possible to check whether any class of the current set of classes contains a significantly smaller count of anomalies compared to other classes of the current set of classes. Such an inequality may be an indication that further training is involved. It would alternatively or additionally be possible to define target populations for one or more of the classes. For instance, the target populations could be defined based on available prior knowledge: for example, such prior knowledge may pertain to a frequency of occurrence of respective defects. To give an example, it would be possible that so-called “line break” defects occur significantly less often than “line merge” defects; accordingly, it would be possible to set the target populations of corresponding classes so as to reflect the relative likelihood of occurrence of these two types of defects. On the other hand, imbalanced data can be resolved based on indicating the same or similar target populations for each class.

Multiple anomalies can be concurrently presented to the user, and the method can further comprise grouping and/or sorting the multiple anomalies for presentation to the user. More specifically, by sorting and/or grouping the anomalies, the annotation can be further facilitated for the user. For example, it is possible that comparably similar anomalies—thus having a high likelihood of being annotated with the same label—will be arranged next to each other when presented to the user in a graphical interface. Thus, the user can easily annotate such anomalies based on a single user interaction, e.g., by drag and drop.

It is generally desirable that the at least one decision criterion comprises a context of the selected at least one anomaly with respect to the semiconductor structures. In this way, the decision criterion is not only based on the feature vector of the at least one anomaly itself, but also on the local context of the anomaly. The local context can contain important information for the correct classification of the anomaly, thereby improving the selection of anomalies for presentation to the user due to more accurate similarity or dissimilarity measurements. It is beneficial to select a context size large enough to encompass the whole defect, i.e., depending on the expected maximum size of the defects.

In addition, based on the context of the anomalies it would be possible to select anomalies that are occurring at a position of a certain type of semiconductor structure. For example, it would be possible to select anomalies that occur at certain semiconductor devices formed by multiple semiconductor structures. For illustration, it would be possible to select all anomalies—e.g., across multiple classes of the current set of classes of the current classification—that are occurring at memory chips. For example, it would be possible to select anomalies that are occurring at gates of transistors. For instance, it would be possible to select anomalies that are occurring at transistors. Such techniques are based on the finding that oftentimes the type of the defect, and as such its assignment to a defect class by the annotation, will depend on the context of the semiconductor structure. For instance, a gate oxide defect is typical in the context of a gate of a field-effect transistor, whereas a broken interconnection defect can occur in various kinds of semiconductor structures.

The at least one decision criterion can generally implement at least one member selected from the group consisting of an explorative annotation scheme and an exploitative annotation scheme. The explorative annotation scheme, in general, can pertain to selecting anomalies for annotation by the user that have not been previously annotated with labels by the user and which are dissimilar to such samples that have been previously annotated. Thereby, the variability of the spectrum of anomalies can be efficiently traversed, facilitating a steep learning curve of the anomaly classification algorithm to be trained. It would also be possible to select such anomalies which have a high similarity measure with previously selected anomalies. This corresponds to an exploitative annotation scheme. An exploitative annotation scheme can, for example, pertain to selecting anomalies for presentation to the user which have not been annotated with labels by the user, and which have a similar characteristic to previously annotated samples. Such similarity could be determined by unsupervised or semi-supervised clustering or otherwise, e.g., also relying on the anomalies being assigned to the same predefined class or set of classes by the anomaly classification algorithm.

During training of the anomaly classification algorithm, the at least one decision criterion can differ for at least two iterations of the inner iterations. To obtain optimal results in a short period of time a change between different strategies for the selection of training data is beneficial, for example, a change between an explorative and an exploitative strategy. In this way, the variation of the training data is explored, but at the same time the gained knowledge is consolidated and annotation effort reduced.

The decision criterion could further comprise selecting the at least one anomaly based on an unsupervised or semi-supervised clustering of the detected plurality of anomalies. To this end, the method could comprise performing an unsupervised or semi-supervised clustering of the detected plurality of anomalies. In this way, the similarity between the anomalies could be determined. The clustering algorithm may perform a pixel-wise comparison between multiple anomalies or tiles depicting the multiple anomalies. The likelihood of anomalies assigned to the same cluster being also assigned to the same class is high. Performing an unsupervised or semi-supervised clustering is especially helpful if cold-starting is used and no current classification of the anomalies is available. In this case, an unsupervised or semi-supervised clustering of the anomalies can be computed and one of the clusters could be selected for presentation to the user. An unsupervised or semi-supervised clustering can be computed in each outer iteration, or whenever the current detection of the plurality of anomalies in the imaging dataset changes. For example, an unsupervised or semi-supervised clustering can be computed if the current detection of the plurality of anomalies is determined for a larger subset of the imaging dataset than in the previous outer iteration, e.g., during cold-starting. The clustering can take into account the current detection of anomalies and/or the current classification of anomalies of one or more previous outer or inner iterations. For example, the clustering can be initialized using the current detection of anomalies and/or the current classification of anomalies of one or more previous outer or inner iterations. In this way, in each subsequent outer or inner iteration, more prior knowledge in the form of annotated or classified anomalies is available for computing clustering. Performing a semi-supervised clustering, i.e. a clustering based on mostly unlabeled samples and some labeled samples, could reduce the time used for training and improve the quality of the clustering. Despite some user effort for labeling, this method might still reduce the overall user effort used for training the whole method and could, thus, be useful for cold-starting.

Many different formulations of decision criteria for selecting one or more clusters for presentation to the user are conceivable. A decision criterion can concern any property of the cluster, for example a property of the anomalies contained within the cluster or a property of the cluster within the clustering, e.g., with respect to the other clusters of the clustering. A decision criterion can, for example, concern the size of the cluster or the distribution of the anomalies within the cluster, e.g., the mean or variance or some other statistical measure or moment of the distribution of the anomalies within the cluster. A decision criterion can, for example, concern the similarity or dissimilarity of clusters. A decision criterion can, for example, concern the distance of clusters within a cluster tree or the tree level of a cluster.

The following decision criteria can be desirable for selecting a cluster for presentation to the user, which is obtained by an unsupervised or semi-supervised clustering algorithm.

According to an example, one of the at least one decision criterion comprises selecting a cluster for presentation to the user according to a between group similarity measure, which measures the similarity between the selected cluster and one or more previously presented clusters. In particular, the between group similarity measure of the selected cluster can lie above a threshold. Thus, a cluster with at least a minimum similarity to one or more of the previously selected clusters can be selected. In this way, an exploitative annotation scheme can be realized, or fine-tuning of the anomaly classification algorithm can be carried out by requesting annotations for similar clusters. If no previously selected clusters exist a cluster can be selected according to a different criterion, e.g., the largest cluster or a randomly selected cluster.

According to an example, one of the at least one decision criterion comprises selecting a cluster for presentation to the user according to a between group dissimilarity measure, which measures the dissimilarity between the selected cluster and one or more previously presented clusters. In particular, the between group dissimilarity measure of the selected cluster can lie above a threshold. Thus, a cluster with at least a minimum dissimilarity to one or more of the previously selected clusters can be selected. In this way, an explorative annotation scheme can be realized. If no previously selected clusters exist a cluster can be selected according to a different criterion, e.g., the largest cluster or a randomly selected cluster.

According to an example, one of the at least one decision criterion comprises selecting a cluster for presentation to the user according to a group novelty measure, such that the selected cluster is most dissimilar to one or more of the previously selected clusters and has not been annotated yet. In this way, an explorative annotation scheme can be realized. If no previously selected clusters exist in the first outer iteration a cluster can be selected according to a different criterion, e.g., the largest cluster or a randomly selected cluster.

The similarity of clusters can, for example, be measured by comparing the anomalies associated with the clusters, e.g., by using a between group similarity measure described above. The dissimilarity of clusters can, for example, be measured by comparing the anomalies associated with the clusters, e.g., by using a between group dissimilarity measure described above. The similarity or dissimilarity of clusters can, for example, be measured by using a cluster distance that is inherent to the clustering algorithm, for example the distance of cluster centroids or cluster means or other specific cluster elements or of the variances of the anomalies associated with the clusters, e.g., an L2-distance or a Mahalanobis distance, or a distance within a cluster tree measuring the lengths of the paths between the clusters, or a distance between the distributions of the anomalies associated with the clusters, e.g., a Kullback Leibler divergence. A large distance indicates a low similarity and a high dissimilarity, a small distance indicates a high similarity and a low dissimilarity.

According to an example, the at least one decision criterion comprises selecting a cluster for presentation to the user according to the size of the cluster and/or according to the distribution of the anomalies within the cluster, e.g., according to the mean or variance or some other moment or statistical measure of the distribution of the samples within the cluster. Thus, for example, the largest clusters can be annotated first to obtain a large number of samples for training the anomaly classification algorithm. In another example, small clusters can be annotated first, since the anomalies of these clusters belong to the same class with a high likelihood and involve little annotation effort. For example, clusters with small variance between the samples can be selected for annotation, since they probably belong to the same class and involve little annotation effort. In another example, clusters with high variance between the samples can be selected for annotation in order to provide valuable information for class discrimination to the classifier to improve the accuracy of the method.

According to an example, the user interface is configured to present multiple clusters to the user, to let the user select one or more clusters from the presented multiple clusters and to let the user assign one or more class labels of a current set of classes to the selected clusters. In this way, the annotation of clusters is very efficient, since the user can select the clusters most suitable for annotation from a larger number of clusters.

It is especially beneficial if the unsupervised or semi-supervised clustering is a hierarchical clustering method. The hierarchical clustering method is used to compute a cluster tree.

The root cluster of the cluster tree is a cluster that has no parent. A leaf cluster of the cluster tree is a cluster that has no child clusters. An internal cluster of the cluster tree is a cluster that has one or more child clusters. The root cluster is part of the internal clusters. Each cluster of the cluster tree comprises a set of samples, e.g., anomalies or feature vectors associated with the anomalies.

In the computed cluster tree, the root cluster contains the detected plurality of anomalies, each leaf cluster contains one single anomaly of the detected plurality of anomalies and for all internal clusters of the tree the following applies: for an internal cluster with n child clusters let aᵢ, i ∈ {1, . . . , n} indicate the set of anomalies of child cluster i, then {a₁, . . . , aₙ} is a partition of the set of anomalies contained in the internal cluster. This means, that each anomaly of a parent cluster is assigned to exactly one of the child clusters. The tree level of a cluster is the number of edges along the unique path between the cluster and the root cluster.

The hierarchical cluster tree can be built via agglomerative clustering methods or divisive clustering methods.

The hierarchical clustering method can comprise an agglomerative clustering method, where two clusters are merged, starting from the leaves of the cluster tree, based on a cluster distance measure. An agglomerative hierarchical clustering can for example be computed via the hierarchical agglomerative clustering (HAC) algorithm. This method initially assigns each sample to a separate leaf cluster. Based on a cluster distance measure the distance between each two different clusters is computed. For the two clusters with the lowest cluster distance measure a new parent cluster is added to the tree containing the samples from both clusters. The process can continue until a cluster is created, which contains all samples in its cluster—this is the root cluster.

The cluster distance measure can be applied to measure the distance between two clusters each containing a set of anomalies. The cluster distance measure can comprise a function of pairwise distances, each between an anomaly of the first and an anomaly of the second cluster of the two clusters. For measuring pairwise distances between anomalies, the distance measures d(xᵢ, xⱼ) defined in the table above can be used. Let A and B be two clusters of the cluster tree. Then the cluster distance measure CD between A and B can for example be measured in the following ways:

| | |
|---|---|
| CD(A, B) = min{d(a, b)\|a ∈ A, b ∈ B} | Minimal distance of all anomaly |
| | pairs from both clusters |
| CD(A, B) = max{d(a, b)\|a ∈ A, b ∈ B} | Maximal distance of all anomaly |
| | pairs from both clusters |
| CD(A, B) = mean{d(a, b)\|a ∈ A, b ∈ B} | Average distance of all anomaly |
| | pairs from both clusters |
| CD(A, B) = median | Median distance of all anomaly |
| {d(a, b)\|a ∈ A, b ∈ B} | pairs from both clusters |
| CD(A, B) = d(ā, b̅) | Distance of centroids ā, b̅ of |
| | the clusters |
| $CD ( A , B ) = \frac{d {( \overline{a} , \overline{b} )}^{2}}{\frac{1}{\vert A \vert} + \frac{1}{\vert B \vert}}$ | Ward's minimum variance method, where ā, b̅ are the centroids of theclusters |

The cluster distance measure can be computed based on Ward's minimum variance method, which measures the increase in variance when two clusters are joined. The lower the increase in variance is, the lower is the cluster distance and the earlier the clusters will be merged by the hierarchical clustering algorithm yielding an internal cluster closer to the bottom of the tree.

The pairwise distances can also be measured between feature vectors of the respective anomalies. As described above, the feature vector of an anomaly can contain raw or pre-processed imaging data, the activation of a layer of a neural network, such as the penultimate layer, when presented with the anomaly as input. Here again, the activation of a layer, e.g., the penultimate layer, of a VGG16 neural network trained on the ImageNet database can be used as feature vector. Alternatively, as described above, the feature vector of an anomaly can contain a histogram of oriented gradients of the anomaly.

The hierarchical clustering method could also comprise a divisive clustering method, where a cluster is iteratively split, starting from the root cluster of the cluster tree, based on a dissimilarity measure between the anomalies contained in the cluster.

A divisive hierarchical clustering can be computed via the divisive analysis clustering (DIANA) algorithm. This method initially assigns all samples to the root cluster. For each cluster, two child clusters are added to the tree and the samples contained in the cluster are distributed between these child clusters based on a function. This process is continued until every sample belongs to a separate leaf cluster. The function measures dissimilarities between samples contained in the cluster. The DIANA algorithm determines the sample with the maximum average dissimilarity and then moves all objects to this cluster that are more similar to the new cluster than to the remaining cluster.

If a clustering method is used, the decision criterion can comprise selecting a cluster of the cluster tree for presentation to the user. Since the clusters are computed based on a cluster distance measure the anomalies belonging to the same cluster are also likely to be annotated with the same class label by the user, thus reducing the annotation effort.

It is especially beneficial if the user interface is configured to allow the user to select a cluster suitable for annotation, by iteratively moving from the current cluster to its parent cluster or to one of its child clusters in the cluster tree. In this way, the knowledge contained in the cluster tree can be exploited to reduce the annotation effort for the user.

If, on the one hand, the currently selected cluster contains samples from two or more different classes, it may be helpful to move to one of the child clusters of the current cluster in order to reduce the number of classes present in the cluster. This process can be continued until all samples of the current cluster can be assigned to the same or a small number of classes, so only a single or a small number of user interactions is used for annotation.

If, on the other hand, the currently selected cluster contains only samples from a single or very few classes, it may be helpful to move to the parent cluster in order to increase the number of samples simultaneously assigned to a class by the user. Based on the hierarchical cluster tree, the annotation effort for the user is reduced, since the user can interactively adapt the resolution of the current cluster.

To facilitate the cluster selection, the user interface can be configured to display a section of the cluster tree containing the currently selected cluster, and to let the user select one of the displayed clusters of the section of the cluster tree for annotation. The currently selected cluster can be displayed together with one or more of its parent clusters and/or one or more of its child clusters. For example, along with the current cluster its parent cluster and/or its child clusters could be displayed. Additionally, the parent cluster of the parent cluster and/or the child clusters of the child clusters could be displayed. Further tree levels of parent clusters and/or child clusters could be displayed. Furthermore, a larger section of the cluster tree around the current cluster could be displayed, so the user could directly select a cluster several tree levels up or down from the current cluster or on the same tree level as the current cluster. The user interface can be configured to let the user select the number of tree levels of the cluster tree displayed to the user.

According to an example, one of the at least one decision criterion comprises selecting a cluster for presentation to the user according to the distance of the cluster from one or more of the previously selected clusters within the cluster tree. In this way a group similarity measure or a group dissimilarity measure or a group novelty measure can be implemented. The distance between clusters in a cluster tree can be measured as the lengths of the paths between the clusters. The group novelty measure can be implemented by selecting a cluster, whose distance to one or more of the previously selected clusters lies above a threshold and has not been annotated yet, or which is farthest from one or more of the previously selected clusters of the cluster tree and has not been annotated yet, for presentation to the user. A group similarity measure can be implemented by selecting a cluster, whose distance to one or more of the previously selected clusters lies below a threshold. A group dissimilarity measure can be implemented by selecting a cluster, whose distance to one or more of the previously selected clusters lies above a threshold.

According to an example, one of the at least one decision criterion comprises selecting a cluster for presentation to the user according to the tree level of the cluster in the cluster tree. For example, during the first outer iterations, smaller clusters at higher tree levels can be selected, whereas during later outer iterations larger clusters at lower tree levels can be selected. In another example, a cluster on the same or a similar tree level as one or more of the previously selected clusters is selected for presentation to the user. In another example, a cluster a specific number or range of tree levels up or down from the one or more of the previously selected clusters is selected for presentation to the user. In this way, annotation is very effective and involves little user effort.

In general, the method can comprise two or more of the previously described decision criteria for the selection of the at least one anomaly for presentation to the user.

For example, it would be possible that multiple anomalies are selected for presentation to the user, and the multiple anomalies are selected to have a low similarity measure with respect to the one or more further anomalies having been selected in one or more previous iterations, but have a high similarity measure between each other. Thus, the selection can be implemented such that batches of similar anomalies most distinct from the anomalies annotated so far are selected for presentation before selecting batches of anomalies similar to the ones annotated so far. This helps to concurrently achieve (i) a steep learning curve of the workflow, as well as (ii) facilitating batch annotation, thereby lowering the manual annotation effort.

It would also be possible to select such anomalies which have a high similarity measure with previously selected anomalies. This corresponds to an exploitative annotation scheme. An exploitative annotation scheme can, for example, pertain to selecting anomalies for presentation to the user which have not been annotated with labels (e.g., have not been manually annotated by the user), and which have a similar characteristic to previously annotated samples. Such similarity could be determined by unsupervised or semi-supervised clustering or otherwise, e.g., also relying on the anomalies being binned in the same class of the current set of classes. In this way, an exploitative annotation scheme could be implemented.

It would also be possible to select anomalies for presentation which are assigned to a specific class and the class is different from the classes of the previously annotated samples. Thereby, it is possible to exploit the variability of the spectrum of classes in the annotation. A steep learning curve can be ensured. In this way, an explorative annotation scheme could be implemented.

It would also be possible to select a cluster from a cluster tree for presentation, which is maximally dissimilar from the previously presented cluster or from the previously annotated cluster. Thus, the anomalies presented to the user are similar and can be annotated with a single or few user interactions, but at the same time the space of defects can be quickly explored due to their dissimilarity to previously annotated clusters.

It would also be possible to select a cluster of a cluster tree containing anomalies which were assigned to the unknown class in the current classification of the multiple anomalies. In this way, unknown defects can be easily discovered and annotated, since the anomalies in the same cluster most likely belong to the same, still unknown, defect.

It would also be possible to select a cluster of a cluster tree containing a large number of anomalies which were assigned to the same class in the current classification of the multiple anomalies. Based on such large clusters of anomalies class refinement strategies could be explored, since it might make sense to split the large class into several subclasses. On the other hand, if two child clusters contain only very few samples, which are assigned to different classes, it might make sense to merge these clusters and at the same time replace the two classes by a single more general class.

The cluster tree could, in general, be useful for an adaptation of the current set of classes. By reviewing the clusters of the cluster tree while travelling along the structure of the cluster tree, the user may discover new defect classes, refine existing classes by adding subclasses or merge classes with only few samples.

It could also be helpful to organize the class labels in a hierarchical way as well, e.g., by discriminating between defect and nuisance on a first level and/or by grouping the defects and/or nuisances based on their similarity in the respective subtrees using hierarchical clustering. In this way, the hierarchy of the labels of the current set of classes represents the similarity between the classes. For example, the class label hierarchy can be utilized to define or estimate a cost for misclassification, e.g., the cost for misclassifying defects from similar classes should be lower than for misclassifying defects from dissimilar classes. Also, such hierarchical information can be utilized for cross learning between different use-cases. For instance, defect classes not existent in one use-case can be compared to those unique to other use-cases by having a common defect class, which exists in both use-cases, for comparison. The hierarchy can, thus, be used to assess the similarity between a defect class A occurring only in a first use-case and a defect class B occurring only in a second use-case based on their similarity to a class C occurring in both use-cases. This similarity information can be used to pre-train machine learning models based on a model trained for another use-case. Then, finetuning can be performed based on the use-case at hand. Therefore, cross learning can be viewed as pre-training a machine learning model based on a different use-case with similar defect classes. In this way, knowledge can be transferred from one use-case to another and training can be carried out more efficiently by exploring prior knowledge about the similarity of defects in a hierarchical defect tree.

Knowledge about a class hierarchy could at the same time be used to improve the cluster trees. For example, the first split in the cluster tree could be implemented to discriminate between nuisance and defects. Thus, the cluster tree might represent the different classes in a better way leading to cleaner clusters, i.e., clusters whose anomalies belong to fewer classes.

Concurrently presenting multiple anomalies to the user can enable batch annotation. For instance, the user may click and select two or more of the multiple anomalies and annotate them with a joint action, e.g., drag-and-drop into a respective folder associated with the label to be assigned. In this way, the annotation effort can be reduced significantly.

A further reduction of the annotation effort can be achieved by batch assigning a plurality of labels to a batch of anomalies. I.e., for a given batch of anomalies, the user only selects valid classes present in the group instead of annotating every single anomaly with the correct class label. In addition, where a batch of anomalies is annotated in one go, it is possible that unintentional errors in the annotation occur. Thus, there can be labelling noise in annotated samples, i.e., erroneous labels annotated by the user. Such labels are sometimes referred to as weak labels, because they can include uncertainty. The underlying anomaly classification algorithm can then deal with this (un)intentional label uncertainty. By relying on such concurrent presentation of multiple anomalies to the user, annotation can be implemented in a particularly fast manner. For example, if compared to a one by one annotation in which multiple anomalies are sequentially presented to the user, batch annotation can significantly speed up the annotation process.

In order to enable cold-starting of the workflow, it is important that the set of classes the anomalies are assigned to is not used in advance. Oftentimes, for a given wafer it is unclear which defects the user will encounter during an inspection of the imaging dataset. Furthermore, it may be helpful to add further classes to the current set of classes to improve the performance of the workflow, for example by adding nuisance classes, an unknown class for unknown or irrelevant defects, by separating a defect class into two subclasses or by merging two classes into a single class. If, on the other hand, prior knowledge about the defects of the wafer is available, the current set of classes can be initialized as a predefined set of classes. Alternatively, the current set of classes can be initialized as an empty set. In order to increase the amount of classes available for annotation, the annotation of the at least one anomaly in step iii.b. can comprise the option to add a new class to the current set of classes. The user interface can be configured to let the user add a new class to the current set of classes. In this way, the current set of classes can be refined. A class refinement can pertain to an annotation scheme in which anomalies that already have annotated labels (e.g., annotated manually by the user) are selected for presentation to the user for annotating, so that the labels can be refined, e.g., further subdivided or merged. This may be helpful in case different defects are assigned to the same defect class.

Upon adding a new class to the current set of classes, the user can be offered an option to assign previously labeled training data to the new class. In this way, a previous annotation can be corrected or improved based on the newly added class. For example, if a class is split into two subclasses a review of the previously annotated samples in this class may be used.

It is also possible to correct the class labels. This might be helpful to further explore anomalies assigned to the unknown class by adding further defect and/or nuisance classes and re-assigning the anomalies classified as unknown to these classes.

In general, a so-called open-set classification algorithm can be used, which does not treat the set of classes as a fixed parameter but allows the set of classes to vary over the course of training. In contrast, traditional classifiers assume that the classes are known before training. Open-set classifiers can detect samples that belong to none of the classes of the current set of classes. To this end, they typically fit a probability distribution to the training samples in some feature space and detect outliers as unknowns. Using an open-set classifier as anomaly classification algorithm, thus, allows adding new classes during training and at the same time avoids incorrect assignments of samples.

The current set of classes can contain at least one defect class and at least one nuisance class. By assigning anomalies, which are not defects, to a nuisance class, the classifier can learn to discriminate between real defects and nuisance, i.e., anomalies, which are due to other reasons and are, thus, not interesting to the user. In this way, most of the defects can be detected correctly (i.e. a high capture rate), while keeping the nuisance rate at a low level. This ensures workflow results of high quality in a shorter period of time and reduces annotation effort at the same time.

There may also be an unknown anomaly class for unknown anomalies, i.e., anomalies that do not have a good match with any of the remaining classes. This can improve the precision rate and the nuisance rate of the workflow by reducing the number of misclassifications.

In an implementation, the selection of a machine learning algorithm comprises selecting one or more of the following attributes of the machine learning algorithm: a model architecture; an optimization algorithm for carrying out the training; hyperparameters of the model and the optimization algorithm; an initialization of the parameters of the model; pre-processing techniques for the training data.

A model architecture encompasses the type of machine learning model, e.g.,
Supervised machine learning methods such as deep learning architectures, e.g. convolutional neural networks (CNN), recurrent neural networks (RNN), generative models such as generative adversarial networks (GAN), autoencoders, reinforcement learning, Boltzmann machines, deep belief networks, support vector machines (SVM), random forests, decision trees, regression models, Bayes classifiers, k-nearest-neighbors, multilayer perceptrons;
Unsupervised or semi-supervised machine learning methods such as clustering architectures, e.g. self-organized maps, k-means, expectation maximization, one class support vector machines.

The optimization algorithm for carrying out the training of the model depends on the selected model architecture, e.g., gradient descent, stochastic gradient descent, backpropagation or linear optimization methods such as the interior point algorithm.

Hyperparameters of the model and the optimization algorithm refer to parameters, which determine the structure of the machine learning model and its training. They are external to the model, i.e., not part of the model itself, and their value cannot be estimated from data but is usually selected by the user or via heuristics. Examples of hyperparameters are the number of hidden layers and units per layer of a neural network, the loss function, the activation function of the units, the learning rate of the optimization algorithm, the batch size, the kernel type of SVMs, the number and maximum depth of trees grown by a random forest, the maximum depth of a decision tree, the k in k-nearest-neighbors.

In contrast, a model parameter is a configuration variable that is internal to the model and whose value can be estimated from data, i.e., the objective of the training of the machine learning algorithm is to find suitable values for the model parameters. Examples of model parameters are the weights of a neural network, the hyperplane parameters of an SVM, the splitting features of a random forest.

An initialization of the parameters of the model, thus, is a set of values for the model parameters, e.g., a set of initial values for the weights of a neural network.

The workflow can also comprise pre-processing selected training data before training or re-training a machine learning algorithm by applying at least one measure from the group consisting of data augmentation, contrast-removal, edge enhancement, image filtering and image normalization. Pre-processing techniques can be applied to obtain predictions of higher accuracy. Image-normalization can be applied to remove contrast variations. Data augmentation means the artificial creation of additional training data based on the available training data, e.g., by rotating the samples. Contrast removal and/or edge detection and enhancement can make important structures more visible. Image filtering relates to the application of filters to the image, e.g., Gabor filters or Gaussian filters.

One or more attributes of the machine learning algorithm can be selected based on specific application knowledge. In this way, the predictions of the model for unknown data become more accurate and training can be carried out in a shorter period of time.

For example, the minimum desired depth of a neural network can be estimated if the maximum size of the structures, here the anomalies, is known. A similar approach can be applied to models based on SVMs or Random Forests.

Furthermore, pre-processing techniques can be selected based on the applied imaging technique. For example, some imaging techniques are based on voltage contrasts. Here, short-circuits are brighter, but structurally similar to non-defect structures. In order to be able to reliably discriminate such defects from non-defects, it is better not to normalize the imaging dataset or interest-region in this case.

If the smallest size of structures on the wafer is known, then the smallest size of structures in terms of pixels in the imaging dataset is also known. This information can be used to classify anomalies as nuisance, for example by thresholding their area. If the area of an anomaly is smaller than the smallest structure on a wafer then it is a nuisance.

It is desirable, if the one or more outer iterations comprise a modification step containing an option to modify one or more attributes of the machine learning algorithm. Such a modification can be carried out by the user, or it can be done automatically, e.g., based on auto machine learning techniques. Auto machine learning techniques aim at automatically performing one or more steps of the training of a neural network, e.g. by automatically selecting a machine learning model, by automatically tuning the hyperparameters of the machine learning model or by automatically preparing the training data, e.g. by applying preprocessing. In this way, often simpler solutions outperforming hand-designed models can be obtained in less time.

The modification step makes the workflow very flexible, since the user can interactively adapt each building block by interactively adjusting attributes of the machine learning algorithms involved, e.g., hyperparameters as well as the model architecture. In this way, the user can directly go back and forth to previous or subsequent steps in the workflow if they see a desire for improvement there. Despite modifications of the algorithms, the entire amount of previously annotated training data can still be used for training. Thus, samples already annotated by the user will be retained as part of every following training step i.e., even though the user is not presented again with them they are included in the training. Yet, if a user opens an additional class the user has the option to review and modify their previous annotations again. The inclusion of previously annotated data allows a targeted improvement of the workflow, leading to a very efficient training and, thus, a lower number of training cycles and user interactions.

The workflow can comprise a reviewing step with one or more of the following options: visualizing the current classification of the plurality of anomalies; determining measurements of the plurality of anomalies; modifying the current classification or the current detection of the plurality of anomalies; modifying the current set of classes; modifying the class affiliations of the annotated training samples. These modifications can be made via a user interface.

The current classification of the plurality of anomalies can, for example, be visualized by overlaying the anomalies on the imaging dataset view in the user interface. The user can choose which anomaly classes he wants to consider by only displaying these classes. He can navigate through different scan fields of view (sFoVs), inspect images by zooming in/out and obtain details of the detected anomalies or defects, e.g., measurements of the anomalies such as anomaly location, anomaly size, anomaly area etc. In addition, overall defect statistics and classification performance metrics can be computed and displayed, e.g., the precision rate, the nuisance rate or the capture rate for the whole workflow and/or for the anomaly detection algorithm and/or for the anomaly classification algorithm separately. In addition, the current classification of the plurality of anomalies can be modified by the user, i.e., he can correct misclassified anomalies by assigning them to different classes, or he can correct the current detection of anomalies by modifying the boundaries of anomalies, removing whole anomalies or adding new ones. Furthermore, the user can modify the current set of classes by removing classes, renaming classes or adding new classes. He can also modify the class affiliations of the annotated training samples by re-assigning samples to different classes, removing samples or adding new samples to the training data.

Another objective of the review process is to increase the user's confidence in the workflow and the quality of the results. By reviewing the results for a few iterations the user builds trust in the prediction accuracy of the workflow and can get an idea of the issues that still exist. The acceptance of the user, e.g., an expert, is thereby strengthened, since the expert is able to infer the rationale behind the decisions of the automated system.

The method could also comprise a reporting step for exporting information on the training of the workflow for future reference. Among others, defect-level and dataset-level information, metrology details and statistics can be exported. The user can configure the level of detail to be preserved in the report. For example, crops of defects could be stored in the report or high-level intensity histograms. If available, performance metrics such as precision rate, nuisance rate or capture rate for the workflow and/or for the anomaly detection algorithm and/or for the anomaly classification algorithm could be saved. A defect source analysis etc. could also be included. The report can capture high-level information of the datasets used to train the model as well as the underlying defect catalogue. Based on the report, the user could investigate the reasons behind a good or bad performance of a trained workflow, e.g., due to shifts in manufacturing or imaging conditions.

The trained models including the optimized parameters and their attributes described above can be saved during or after the training. During the training of the workflow a pre-trained model for anomaly detection and/or anomaly classification based on previous iterations of the workflow or based on further imaging data, e.g., a model trained on imaging datasets of other wafers or even other image databases, can be loaded. In this way, a previous training can be continued, or a model trained on a different dataset can be refined and applied to the current imaging dataset in order to save time. Alternatively, the model can be newly initialized.

Furthermore, a machine learning classification algorithm can be used that can handle uncertainty in the labels annotated by the user. Thus, it may not be assumed that the labelling is exact, i.e., each anomaly obtains a single exact label. In this way, the annotation effort is reduced, since the user does not have to annotate each single anomaly with the correct label. Therefore, larger sets of anomalies can be concurrently presented and labeled.

The one or multiple outer iterations and/or the multiple inner iterations can be terminated when at least one of the following termination criteria is met:

TABLE 3
example termination criteria for aborting
the outer and/or inner iterations

| | |
|---|---|
| User input | The user may manually stop the training |
| | process, e.g., if in their opinion the |
| | accuracy of the classifier is sufficient or |
| | time is short. |
| All anomalies | The iterations are stopped if all |
| annotated | anomalies in the current detection of the |
| | plurality of anomalies have been |
| | annotated and no more detected |
| | anomalies are available for annotation. |
| Maximum number of user | If a maximum number of user |
| interactions | interactions has been reached, the |
| | iterations may be terminated to keep the |
| | annotation effort for the user to a low |
| | level. |
| Time limit for | If a time limit for annotation has been |
| annotation | reached, the iterations may be terminated |
| | to keep the time spent for annotation to a |
| | low level. |
| Maximum number of | If a maximum number of anomalies has |
| anomalies assigned | been assigned by the user, the iterations |
| | may be terminated to keep the annotation |
| | effort to a low level. |
| Maximum cardinality of | If the current set of classes has reached a |
| the current set of | maximum cardinality, the iterations are |
| classes | terminated to limit the number of |
| | defects. |
| Minimum number of | If a minimum number of samples has |
| samples assigned to | been assigned to each class, the iterations |
| each class | are terminated. In this way, a sufficiently |
| | large training dataset is obtained |
| | allowing meaningful predictions for |
| | each class. |
| Probability of finding | If a specific probability of finding a new |
| a new class | class lies below a threshold, iterations |
| | can be terminated. For example, it would |
| | be possible to model the user annotation |
| | process, e.g., by predicting if further |
| | annotations would likely introduce a |
| | new class into the set of classes. For |
| | example, introduction of new class |
| | labels can be modeled as a Poisson |
| | process. If this probability is sufficiently |
| | low, the process may abort. |
| Target frequency | If a target frequency of training samples |
| | has been reached for the current set of |
| | classes, iterations are terminated. In this |
| | way, a low prediction quality due to |
| | insufficient training data for rare defects |
| | could be avoided by selecting a higher |
| | target frequency; on the other hand, if the |
| | frequency of occurrence is known for |
| | certain defects, iterations could be |
| | terminated when the training data |
| | affiliations reflect this frequency, thus |
| | avoiding long annotation times due to |
| | insufficient training data for very rare |
| | defects. |
| Worst classification | If a worst classification confidence of all |
| confidence | un-annotated anomalies lies above a |
| | threshold, iterations are terminated. For |
| | example, a prediction confidence can be |
| | computed for all un-annotated samples, |
| | and if this prediction confidence lies |
| | above a threshold for each of the un- |
| | annotated samples further annotations |
| | are not used. |
| Targeted performance | If a targeted performance metric has |
| metric | been reached, e.g., a specific precision, |
| | nuisance or capture rate, iterations can be |
| | terminated. |

The imaging dataset could be generated by a SEM or mSEM, a Helium ion microscope (HIM) or a cross-beam device including FIB and SEM or any charged particle imaging device.

In an implementation of the disclosure, the method can comprise determining one or more measurements based on the current classification of the plurality of anomalies.

These measurements are the basis for the user to make decisions, e.g., if training can be terminated, if process parameters should be adapted, or if the currently inspected wafer should be declared as scrap.

In addition, the user interface could be configured to let the user define one or more interest-regions in the imaging dataset, especially die regions or border regions, and the one or more measurements can be computed based on the current classification of the plurality of anomalies within each of the one or more interest-regions separately. In this way, the wafer can be inspected locally, and defect distributions can also be computed locally and for each defect separately. The user could, for example, be interested in monitoring different defects depending on the region of the wafer.

The method could additionally comprise automatically suggesting new interest-regions based on at least one selection criterion and presenting the suggested interest-regions to the user via the user interface. The user could, for example, select a border or a die region. Then, based on a selection criterion comprising, e.g., a similarity measure between different regions of the imaging dataset of the wafer and/or prior knowledge on the spatial location of the target region on the wafer, further border or die regions could be proposed and displayed to the user. The user could then select one, several or all of them to add these to the interest-regions. In this way, the annotation effort for the user is reduced.

The one or more measurements can be selected from the group containing anomaly size, anomaly area, anomaly location, anomaly aspect ratio, anomaly morphology, number or ratio of anomalies, anomaly density, anomaly distribution, moments of an anomaly distribution, performance metrics, e.g., precision rate, capture rate, nuisance rate. The one or more measurements can be selected from the group for a specific defect or a specific set of defects. If one or more interest-regions have been selected by the user, these measurements can be computed locally with respect to the one or more of these interest-regions yielding, e.g., a local anomaly distribution, an average size of a specific defect within a specific region, the variance of the area of a specific defect within a specific region or a precision rate, nuisance rate or capture rate for a specific region, e.g., within border or die regions.

Based on the one or more measurements at least one wafer manufacturing process parameter can be controlled. After computing the measurements, it would be possible to determine the defect density for multiple regions of the wafer based on the result of the workflow. Different ones of these regions can be associated with different process parameters of a manufacturing process of the semiconductor structures. This can be in accordance with a Process Window Qualification sample. Then, the appropriate at least one process parameter can be selected based on the defect densities, by concluding which regions show best behavior.

Based on the one or more measurements and at least one quality assessment rule the quality of the wafer could be assessed. For example, the currently inspected wafer could be marked as scrap if a specific defect has been detected in the corresponding imaging dataset, or if a specified number of defects has been detected within a specific region of the imaging dataset.

Based on the disclosed workflow, cold-starting is possible within reasonable periods of time due to a reduced use of prior knowledge and a reduced annotation effort. As a result, cold-starting a workflow on a 50 mFoV dataset, typically, involves about 24 hours in total, distributed among the steps of the workflow as follows: (1) 4 h image acquisition under optimal conditions, (2) 3 h to draw regulative and/or semantic masks (3) 4 h to train the anomaly detection algorithm (4) 4 h to annotate the anomalies (5) 4 h to train the anomaly classification algorithm (6) 5 h for review and qualification. This is possible using advanced compute infrastructure (6xV100 GPUS), 100TB fast file storage, efficient resource management using e.g., Kubernetes and a robust software design (e.g., dedicated data layer, caching meta-data for display etc.).

In the following, exemplary embodiments of the disclosure are described and schematically shown in the figures.

### BRIEF DESCRIPTION OF THE DRAWINGS

FIG. 1 shows a schematic cell structure of a mSEM image of a wafer without defects;

FIG. 2 shows a defective cell structure containing six different types of defects;

FIG. 3 shows the cell structure of FIG. 2 with marked and classified defects;

FIG. 4 shows a flow chart of a first embodiment of the computer implemented method for the detection and classification of anomalies;

FIG. 5 shows a flow chart of a second embodiment of the computer implemented method for the detection and classification of anomalies;

FIG. 6 shows a flow chart of the data selection routine in FIG. 5;

FIG. 7 shows a flow chart of the anomaly detection routine in FIG. 5;

FIG. 8 shows a flow chart of the annotation step in FIG. 5;

FIG. 9 shows a flow chart of the classification step in FIG. 5;

FIG. 10 shows a flow chart of the review routine in FIG. 5;

FIG. 11 shows a cluster tree obtained by a hierarchical clustering method;

FIG. 12 shows a flow chart of a modified implementation of the annotation step based on hierarchical clustering;

FIG. 13 shows an improved precision-recall curve based on the disclosed disclosure;

FIG. 14 schematically illustrates a system for controlling the quality of wafers in a semiconductor manufacturing fab; and

FIG. 15 schematically illustrates a system for controlling the production of wafers in a semiconductor manufacturing fab.

### DETAILED DESCRIPTION

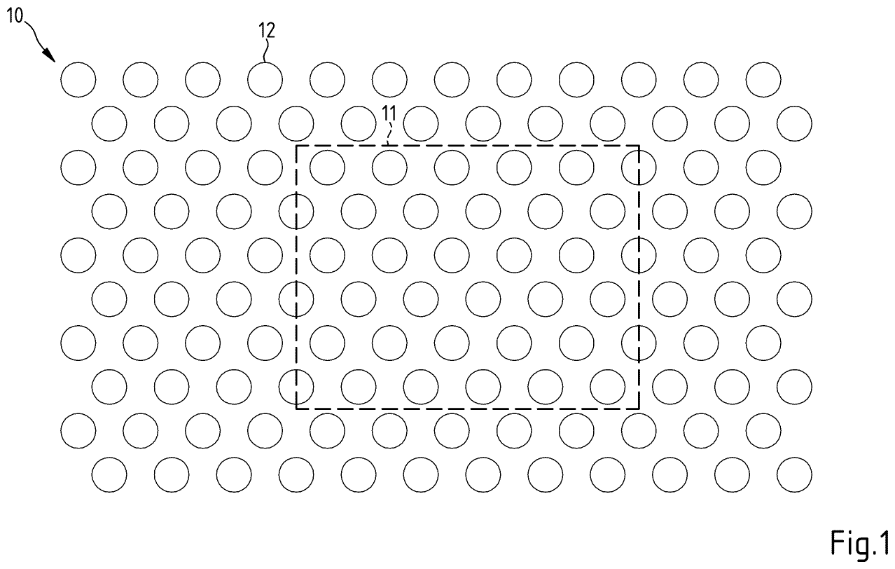

FIG. 1 shows a schematic cell structure 10 of a mSEM image of a wafer 250. In this schematic, the cells 12 are identical and regularly distributed over the entire image without showing any defects. In real data, however, the cell structure 10 can show defects, i.e., deviations of the semiconductor structure from an a priori defined norm, as well as nuisance, i.e., variations due to, for example, imaging artefacts, image acquisition noise, varying imaging conditions, variations of the semiconductor structures within the norm, imperfect lithography, varying manufacturing conditions, varying wafer treatment or rare semiconductor structures. Automatic defect detection methods can have the limitation that they cannot discriminate between defects and nuisance. Thus, most of the detections of these methods correspond to nuisance and only very few to defects leading to a low precision rate. Therefore, a method able to discriminate between defects and nuisance is used. In addition, cold-starting is commonly used in the semiconductor industry, i.e. training a system from scratch without prior knowledge of the imaging dataset 66 or the classes to be encountered. Due to the large size of the imaging datasets 66 this is only feasible if the user effort is kept as low as possible.

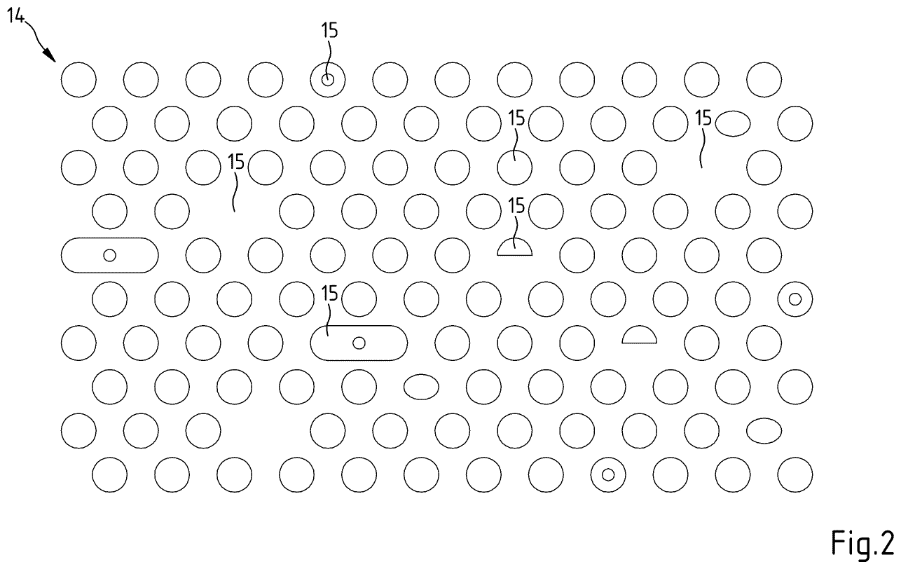

FIG. 2 shows a schematic defective cell structure 14 containing a plurality of anomalies 15. An anomaly 15 is a localized deviation of the imaging dataset 66 from an a priori defined norm, here the deviation from a normed semiconductor structure.

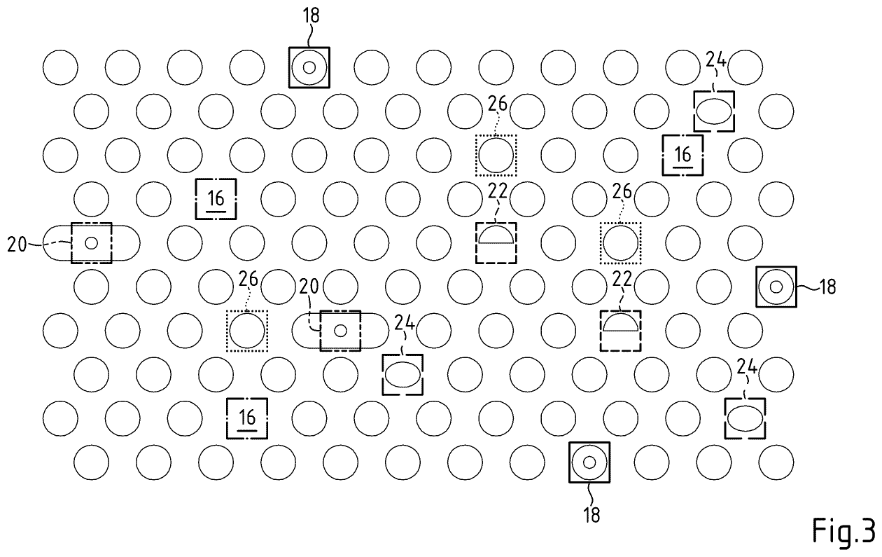

FIG. 3 shows the anomalies 15 of FIG. 2 classified as one of six defect types: open 16, puncture 18, merge 20, half-open 22, dwarf 24 and skid 26. The precise detection and classification of such defects without involving extensive prior knowledge or a high annotation effort from a user is the objective of this disclosure.

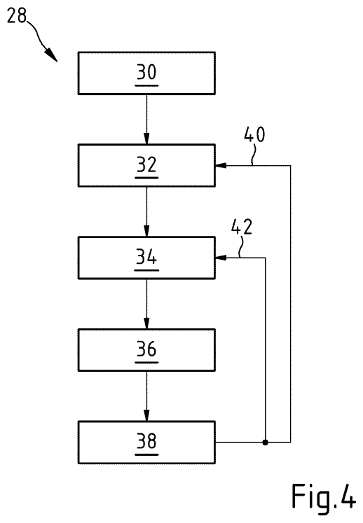

FIG. 4 shows a flowchart of a first embodiment of the computer implemented method 28 for the detection and classification of anomalies 15 in an imaging dataset 66 of a wafer 250 comprising a plurality of semiconductor structures. In a data selection routine 30 a machine learning anomaly classification algorithm is selected, the selection including a model architecture, hyper parameters, an optimization algorithm, an initialization of the model and pre-processing techniques for the training data. For example, a deep learning algorithm based on the VGG16 neural network architecture together with adequate loss functions can be selected. Training can be carried out from scratch, or a pre-trained model can be loaded as initialization. Then, one or multiple outer iterations 40 are executed. At least one of these outer iterations 40 comprises the following steps: in an anomaly detection routine 32 a current detection of a plurality of anomalies 15 in the imaging dataset 66 is determined. The current detection of the plurality of anomalies 15 can be obtained via user annotation or automatically by using an algorithm, e.g., a pattern matching algorithm or a machine learning algorithm. The machine learning algorithm can contain an autoencoder neural network, which is trained on sample data from the imaging dataset 66 itself or on sample data from a CAD wafer filer. Anomalies can be detected based on the difference between a tile of the imaging dataset 66 and a reconstruction of this tile computed by the autoencoder network. The larger the difference the more likely the tile contains an anomaly.

Based on the current detection of the plurality of anomalies, multiple inner iterations 42 are executed. At least one of the inner iterations comprises the following steps: in an anomaly classification routine 34 the selected anomaly classification algorithm is used to determine a current classification of the plurality of anomalies 15 in the imaging dataset 66. In an annotation routine 36, based on at least one decision criterion, at least one anomaly 15 of the current detection of the plurality of anomalies 15 is selected for presentation to a user. The decision criterion can comprise computing a similarity measure or a dissimilarity between different samples. The decision criterion can alternatively or additionally comprise a hierarchical clustering of the anomalies 15 of the current detection of anomalies 15 (or of the tiles containing these anomalies 15) based on a cluster tree 194. The user assigns a class label of a current set of classes to each of the at least one anomaly 15 selected by the decision criterion.

In the first outer iteration 40, the current set of classes can be empty, thus coping with cold-start scenarios without prior knowledge about defect classes in the imaging dataset. The current set of classes can also contain one or more different labels of defects 16, 18, 20, 22, 24, 26. The set of classes can also contain one or more nuisance classes in order to discriminate nuisance from defects, e.g., “imperfect lithography”, “contrast variation”, etc. The set of classes can also contain an “unknown” class, so new or unknown structures or structures with an unclear class affiliation can be assigned to this class and do not interfere with the classification of other samples. The current set of classes can be extended by adding new labels in each inner iteration 42, e.g., by using an open set classifier. In a re-training routine 38, based on anomalies 15 annotated by the user in an inner iteration 42 of the current or any previous outer iteration 40 the anomaly classification algorithm can be re-trained. Since all samples from inner iterations 42 within any previous outer iteration 40 can be re-used for training, the user is able to interactively adapt single building blocks of the system, e.g., by changing the machine learning architecture or hyperparameters of the anomaly detection and/or anomaly classification algorithm, and can still use all of the previously annotated training data for training of the anomaly classification algorithm. In this way, training is very effective.

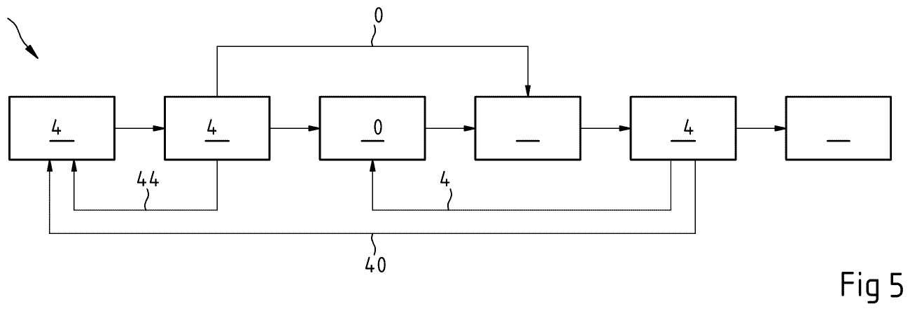

FIG. 5 shows a flowchart of a second embodiment 28′ of the computer implemented method comprising six stages: a data selection routine 46, where the user provides semantic and/or regulative masks for the imaging dataset 66 of the wafer 250; an anomaly detection routine 48, where an anomaly detection algorithm is trained and applied to the masked region; alternatively, a pre-trained model can be loaded, the model could possibly be re-trained and applied; an annotation step 50, where the detected anomalies are manually assigned to the current set of classes; a classification step 52, where an anomaly classification algorithm is trained using the annotated anomalies and applied to the detected anomalies within the masked region; alternatively, a pre-trained model can be loaded in a skipping step 60, the model could possibly re-trained and applied; a review routine 54, where the user can review the classification results, modify class labels, correct misclassified anomalies 15 or decide to refine stages of the workflow during an additional outer iteration 40; a report step 56, where performance metrics summarizing the incidence of various defect classes are compiled in a report.

Based on this workflow interactive defect detection and nuisance rate management can be implemented, which allows for cold-starting.

In detail:

The second embodiment of the computer implemented method 28′ for the detection and classification of anomalies 15 in an imaging dataset 66 of a wafer 250 comprising a plurality of semiconductor structures comprises:

One or multiple outer iterations 40 are executed containing the data selection routine 46 and the anomaly detection routine 48.

In the data selection routine 46 interest-regions 11 of the imaging dataset 66 are selected, e.g., by drawing masks on the imaging dataset 66. The interest-regions 11 can be used to train the anomaly detection and/or the anomaly classification algorithm. The interest-regions 11 can also be used to indicate regions for evaluating the performance of the workflow. In this case, semantic masks can be of interest, i.e., masks containing a specific section of the wafer 250 such as border or die regions, to obtain region-specific measurements. The interest-regions 11 can be expanded or modified during further outer iterations 40 or further intermediate iterations 44 of the workflow. This enables the user to iteratively train the workflow encompassing the entire dataset with minimal effort.

In the anomaly detection routine 48, an anomaly detection algorithm can be selected and trained based on the selected data. If the user is not satisfied with the detection results of the anomaly detection algorithm, the data selection routine 46 can be repeated in a further intermediate iteration 44. Based on modified interest-regions 11 and a re-training of the anomaly detection algorithm the quality of the detection results can be improved. Based on the trained anomaly detection algorithm, a current detection of the plurality of anomalies 15 is determined within the one or more interest-regions 11.

Multiple inner iterations 42 are executed containing the annotation step 50, the anomaly classification routine 52 and, possibly, the review routine 54.

In the annotation step 50 the user annotates the plurality of anomalies 15 by assigning a class label to each of them or to a subset thereof. To reduce annotation effort, active learning can be applied by selecting specific samples from the plurality of anomalies 15 for presentation to the user, e.g., samples that are very similar and probably belong to the same class, or samples that are most dissimilar compared to the samples selected in a previous inner iteration 42. The user annotations can be skipped in a skipping step 60, for example by selecting a pre-trained anomaly classification algorithm and continuing with the anomaly classification routine 52.

In the anomaly classification routine 52 the anomaly classification algorithm can be trained based on the previously annotated anomaly samples. Here, samples from the current inner iteration 42 or from previous inner iterations 62 which were part of a previous outer iteration 40 can be used together. In this way, training can be carried out most effectively and with minimum user effort. Based on the trained anomaly classification algorithm, a current classification of the detected plurality of anomalies is determined, meaning that each anomaly of the plurality of anomalies is associated with one of the classes of the current set of classes.

In the review routine 54 the user can review the current classification computed in the anomaly classification routine 52, He can visualize and navigate through the current classification of the plurality of anomalies 15, determine measurements based on the current classification of the plurality of anomalies 15, e.g., by measuring sizes of one or more anomalies or by computing an anomaly density for a specific region of the imaging dataset 66 or for a specific class, e.g., a specific defect, or he can check performance metrics, modify class labels or correct misclassified anomalies. Furthermore, the quality of the wafer 250 can be assessed based on measurements and at least one quality assessment rule. For example, the wafer 250 can be labeled as defective, if a certain number of anomalies 15 classified as a certain defect is exceeded.

If the user is satisfied with the results, he can move on to the report step 56, where information on the imaging dataset 66, interest-regions 11, the set of classes, defects, statistics and metrics can be exported for future reference, for example by saving the information to a file. Otherwise, if the user is not satisfied with the results, he can go back to the data selection routine 46 and repeat the whole cycle during one or more intermediate iterations 44.

By integrating data selection, anomaly detection and anomaly classification into a single workflow allowing the user to repeat and modify previous stages in the workflow within an intermediate iteration 44, classification results of high quality can be obtained within a short period of time. The reason for this lies in the flexibility of this workflow, since the user can directly visualize and thus react to the current classification results by not only modifying the classification algorithm or its training data within the inner iterations 42, but also by modifying earlier steps such as the anomaly detection algorithm or the selection of interest-regions 11 within the outer iterations 40.

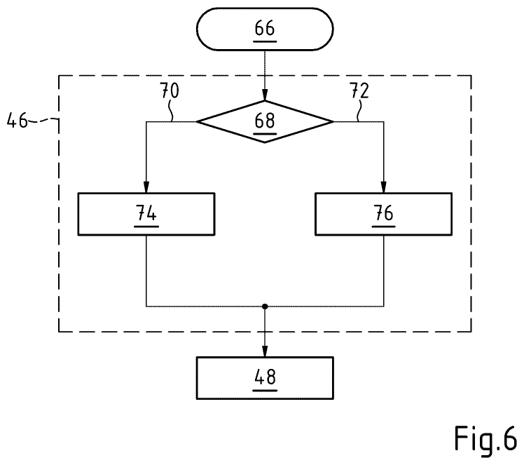

FIG. 6 is a flowchart illustrating an example implementation of the data selection routine 46 based on a given imaging dataset 66. In a decision step 68 the user selects, if the workflow has already been trained (positive answer 70) or if cold-starting is used (negative answer 72). If the workflow has already been trained the user might be interested in evaluating defect rates in different interest-regions 11 of the wafer 250, for example in die regions or border regions. Therefore, the user can indicate semantic masks containing such specific regions in a semantic annotation step 74. Based on a selection criterion the method can automatically suggest further interest-regions 11, e.g., based on their similarity to the user indicated interest-regions 11. For example, the user could mark die regions and the workflow could automatically indicate further die regions to the user via the user interface 236, which the user could add to their data selection. To expedite the selection process cut-copy-paste commands are available for mask selection. Further steps of the workflow, e.g., the anomaly detection routine 48 can then be carried out based on these semantic interest-regions 11.

Otherwise, if cold-starting is used (negative answer 72), the anomaly detection algorithm and the anomaly classification algorithm have to be learned from scratch. But their training can take prohibitively long for large datasets. Therefore the user selects a representative subset of the imaging dataset 66 as interest-region 11. The algorithms are then trained on the one or more interest-regions 11 with a human evaluator in the loop in the subsequent steps within reasonable turnaround times. With increasing confidence in the algorithms, interest-regions 11 can be expanded to cover the entire dataset iteratively.

This process is implemented in the following way: In a regulatory annotation step 76 the user can indicate one or more interest-regions 11 in the imaging dataset 66, which are used for the training and/or application of the anomaly detection algorithm in the anomaly detection routine 48. These regions can be expanded or modified during further outer iterations 40 or further intermediate iterations 44 of the algorithm to include more regions of the imaging dataset 66 containing other defects or nuisances. To make cold starting possible, the user can start with a small interest-region 11, train the anomaly detection and the anomaly classification algorithm based on samples from this region and later on expand the interest-region 11 or add further interest-regions 11 and retrain both algorithms. The selected interest-regions 11 are the input of the subsequent anomaly detection routine 48.

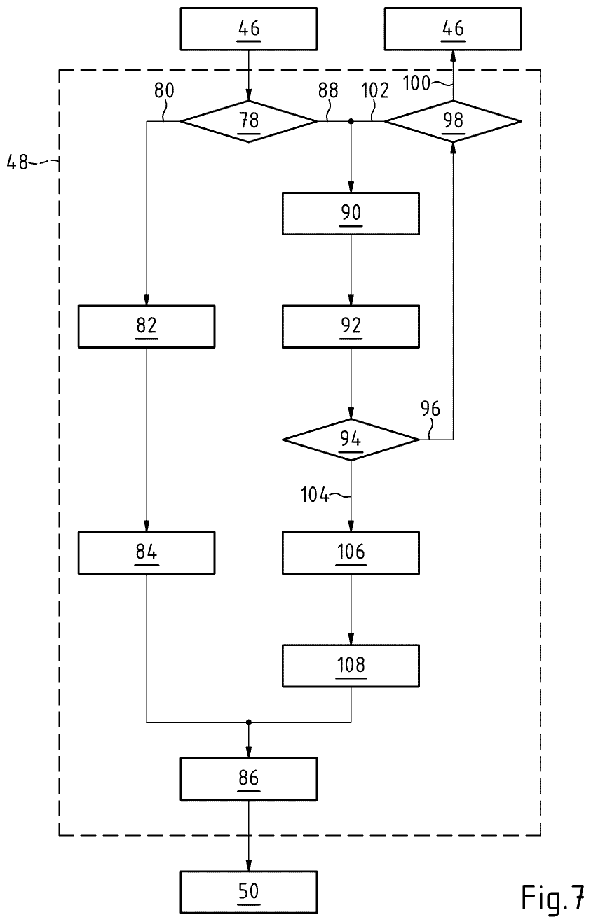

FIG. 7 is a flowchart illustrating an example implementation of the anomaly detection routine 48. The objective of this step is to highlight regions of the imaging dataset 66 that are outliers with respect to the expected patterns in the dataset. During training, the anomaly detection algorithm, such as an autoencoder, is presented with imaging data 66 without (or with very few) defects. The parameters in the anomaly detection algorithm are tuned to reconstruct the imaging data 66 subject to an information bottleneck. Optionally, search for the best model architecture can also be manually or automatically performed. As a result, noise and defect-free images are perfectly reconstructed. On the other hand, image regions with defects are poorly reconstructed. Therefore, thresholding the difference between input and reconstructed input provides proposals for defects or anomalies 15.

The workflow enables users to visualize the input, reconstruction images, adjust thresholds and analyze anomalies e.g., location, size, morphology etc. Should the model performance be unsatisfactory, the user can modify model parameters and/or input data to launch another inner iteration 40 of training of the anomaly detection algorithm.

During evaluation of the workflow, the user can select a pre-trained model, which is applied to the imaging dataset 66 or to the one or more interest-regions 11, respectively. The resulting anomalies can be visualized by the user, and their properties can be analyzed.

The objective of the anomaly detection routine 48 in the workflow is to obtain a high capture rate, e.g., close to 100%, meaning that almost all defects contained in the imaging dataset 66 are identified. This, however, can result in a very high nuisance rate, e.g., 99.99%, meaning that only 1 of 10,000 detected anomalies, actually, relates to a defect. For this reason, the classification step 52 is added to the workflow.

The anomaly detection routine 48 can be implemented in the following way:

In a first decision step 78 the user indicates if he wants to use a pre-trained model (positive answer 80) or if cold-starting is used (negative answer 88). In case a pre-trained model is used, the user selects the model in a model selection step 82.

The term model means a machine learning algorithm including a model architecture, hyper parameters, an optimization algorithm, an initialization of the model parameters and/or data pre-processing methods. Instead of a machine learning algorithm, other anomaly detection algorithms such as but not limited to pattern matching algorithms can be used for anomaly detection. It is also possible to query the user to annotate anomalies in the dataset by hand.

The model is applied to detect anomalies in the selected one or more interest-regions 11 in a model application step 84 yielding a current anomaly detection in a current detection step 86, e.g., by applying thresholds to probabilistic detections.

In case cold-starting is used (negative answer 88), the user selects an anomaly detection algorithm and parameters. In case a machine learning algorithm is selected, the user initializes the current model in a modification step 90 by selecting a model architecture, hyper parameters, an optimization algorithm and/or an initialization of the model parameters, e.g., the weights in case a neural network is selected. Alternatively, a pre-trained model can be selected and re-trained. For anomaly detection an autoencoder model can be used. If training is used, the anomaly detection model is trained on sample data. In an analysis step 92 the user applies the anomaly detection algorithm to the selected one or more interest-regions 11 and analyzes the detection results. In a decision step 94 the user decides if the quality of the results is satisfactory (positive answer 104) or not (negative answer 96). If the user is not satisfied, he decides in another decision step 98 if he wants to modify the one or more interest-regions 11 (positive answer 100) by going back to the data selection routine 46. Otherwise (negative answer 102) the user can modify the anomaly detection algorithm by selecting a different algorithm, model or parameters and possibly re-training the model in steps 90, 92. Once the user is satisfied with the anomaly detection results (positive answer 104) he can set thresholds in a threshold selection step 106. These thresholds can be applied to probabilistic outputs representing uncertainty of the anomaly detection algorithm. Based on these thresholds a binary decision can be taken for each pixel, if it belongs to an anomaly or not. In a saving step 108 the anomaly detection algorithm including the selected model and parameters is stored and can be reloaded as pre-trained model in the model selection step 82 during further iterations of the workflow. Based on the anomaly detection algorithm and the selected thresholds a current detection of anomalies is determined in the current detection step 86. The current detection of anomalies is the input of the annotation step 50.

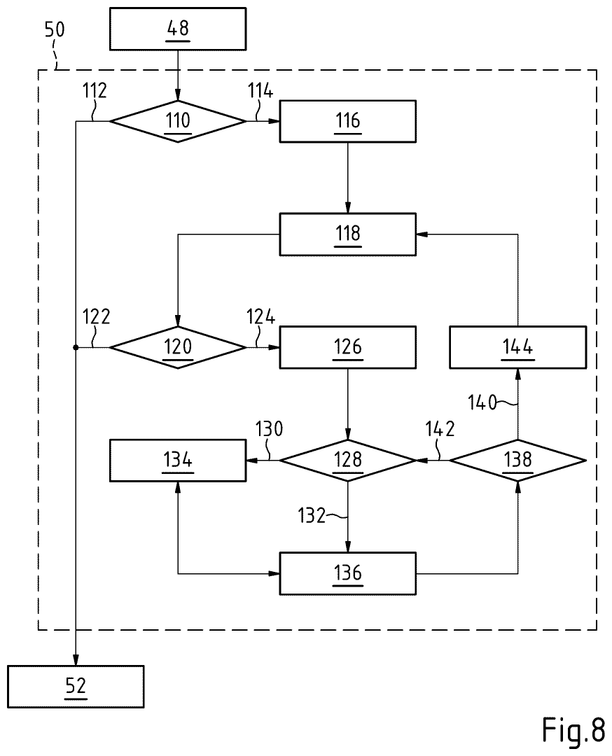

FIG. 8 is a flowchart illustrating an example implementation of the annotation step 50.

The anomalies detected by the anomaly detection algorithm contain outliers and can be over-shadowed by nuisance. e.g., due to image acquisition noise, imperfect lithography, varying manufacturing conditions, miscellaneous wafer treatment, secondary uninteresting defects etc. The annotation step enables the user to discriminate anomalies from nuisance by assigning the anomalies to the current set of classes comprising defects (e.g., missing structure, broken structure etc.) and nuisance.

As labeling individual samples involves large user effort and often results in poor labeling quality, the workflow provides for a group-wise annotation strategy. Here, anomalies 15 are pre-clustered into groups based on their similarity. In each inner iteration 42, the user is presented with an unlabeled anomaly-group, all of which might be binned into a single class, e.g. by the virtue of pre-clustering. As a result, the user not only annotates multiple anomalies in a single click, but also gains an overview of intra-class variations, resulting in better annotation quality. The annotation process can be terminated when, e.g., (1) all anomalies are annotated, or (2) a certain terminal criterion is reached e.g., maximum number of clicks, total time for annotation etc.

In addition, human effort is optimized by enabling the user to allocate distinct class labels to mutually exclusive subsets within a single anomaly group. Further, querying the next anomaly group can be optimized for “novelty”, in that each new anomaly-group should be visually different from the ones annotated before. It is to be noted that the novelty is evaluated on the group level, thereby making it robust to noise and outliers in practical scenarios.

It is assumed that all user defined classes have a minimum number of samples, e.g., 10, so that sufficient data is available for training of a robust anomaly classification algorithm.

The annotation step can be implemented in the following way:

Input to the annotation step is a current detection of anomalies in the one or more interest-regions 11 obtained from the anomaly detection routine 48. In a first decision step 110 the user can decide if he wants to train or re-train the anomaly classification algorithm (positive answer 114) or if he wants to use a pre-trained model (negative answer 112). In the latter case, the workflow directly continues with the anomaly classification routine 52. If the anomaly classification algorithm needs to be trained or re-trained based on further samples (positive answer 114), active learning can be applied to reduce the annotation effort for the user and speed up the training.

For active learning, the plurality of anomalies of the current detection of anomalies is pre-clustered in a clustering step 116. Clustering the anomalies into groups reduces the annotation effort for the user, since groups of anomalies, which are likely to be associated with the same class, can be annotated simultaneously with a single or very few user interactions. To cluster the plurality of anomalies, each anomaly is extracted from the imaging dataset 66, usually together with a surrounding context of the anomaly. For clustering, the raw image data can be used as feature vector, or feature vectors can be computed for the plurality of anomalies. Such a feature vector can, for example, comprise the activation of the penultimate layer of a pre-trained neural network, e.g., the VGG16 network pre-trained on the ImageNet database, when presented with the anomaly as input. Clustering can be based on a similarity measure between the feature vectors of different anomalies, e.g., the cosine similarity measure. The more similar the feature vectors are, the more likely they belong to the same cluster. All the samples of a cluster can then be presented to the user simultaneously in a querying step 118 and the user can—in the optimal case—assign all of the samples to the same class with a single user interaction.

To speed up training, it can be desirable to explore the variation of the anomalies as quickly as possible. To this end, the concept of group novelty can be applied in the querying step 118, meaning that the cluster, which is most dissimilar from the previously presented cluster, is selected for presentation and annotation to the user.

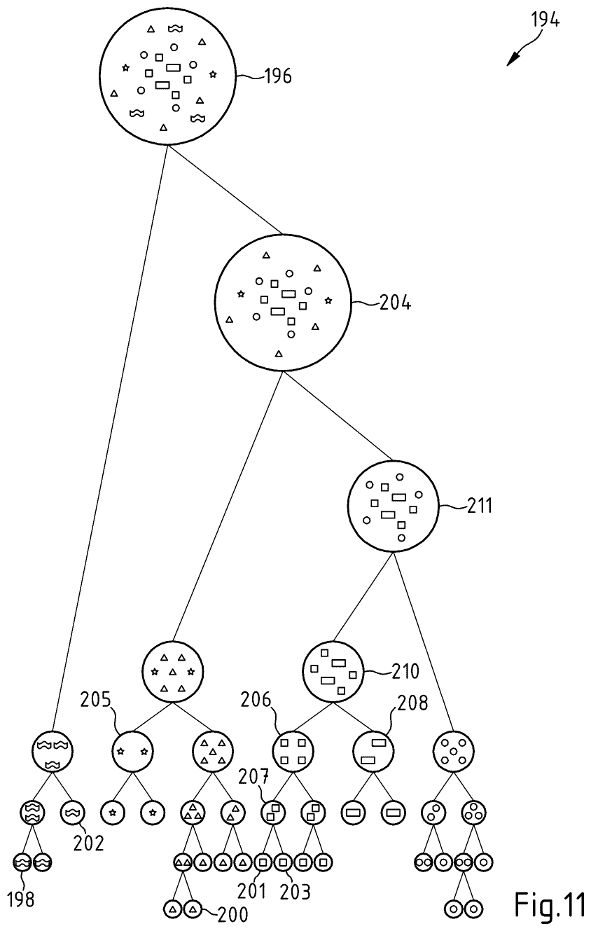

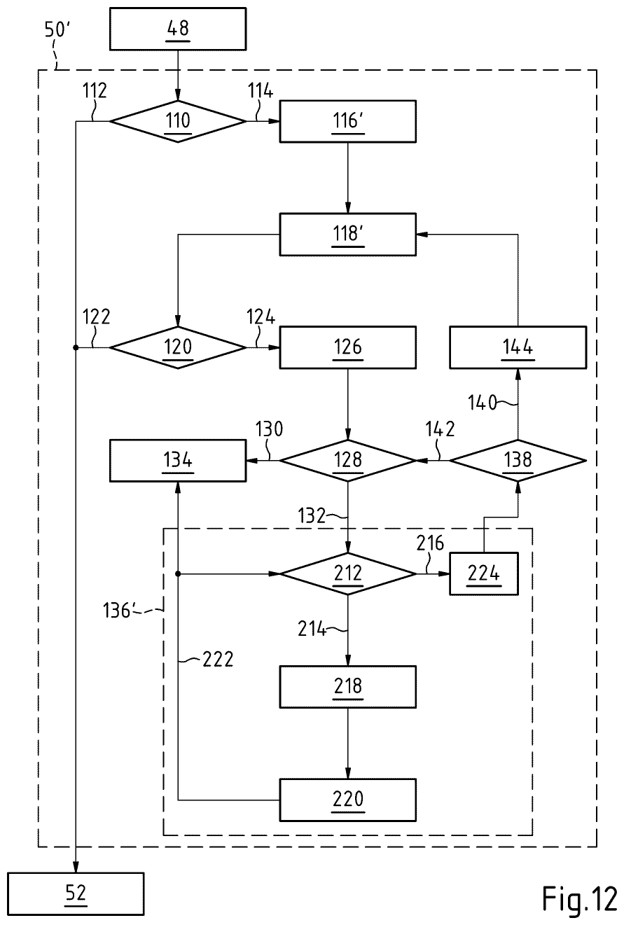

Since the clusters can contain samples from different classes, which cannot be annotated with a single user action, the user can assign different labels to different samples in the same cluster. To facilitate this process, hierarchical clustering is helpful. Based on hierarchical clustering a cluster tree is built, which is further explained with respect to FIG. 11. Starting from a cluster selected from the cluster tree due to a decision criterion, the user can move up or down the cluster tree to modify the resolution of the clusters until he finds a cluster whose samples all belong to the same class. This process is further explained with respect to FIG. 12.

After selecting a cluster for presentation to the user based on the decision criterion in the querying step 118, the user decides in a decision step 120 if he wants to terminate the labeling. In case of a positive answer 122 the workflow proceeds with the anomaly classification routine 52. In case the user wants to continue labeling (negative answer 124), in a visualization step 126 the samples belonging to the selected cluster are visualized via the user interface 236. In a decision step 128 the user decides if a new class label is used for labeling the current cluster. If this is the case (positive answer 130), in a class update step 134 the current set of classes and the user interface 236 are updated to contain the new class label. Otherwise, if no new class label is used for labeling (negative answer 132), the current set of classes does not change. In an allocation step 136 the user can assign one or more samples to one of the classes of the current set of classes. In a decision step 138 it is determined if all samples of the selected cluster are labeled (positive answer 140) or not yet (negative answer 142). In the latter case, the labeling continues with the decision step 128 offering the user an option to add a new label. If all samples of the current cluster are labeled, the labeled dataset is saved in a saving step 144. Then the next cluster is selected in the querying step 118.

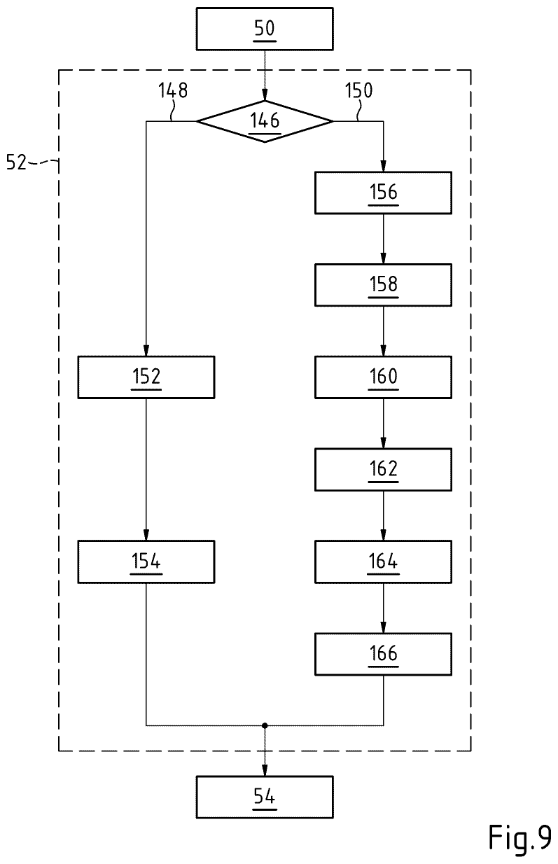

FIG. 9 is a flowchart illustrating an example implementation of the anomaly classification routine 52.

The anomaly classification algorithm aims at segregating the anomalies into user-defined classes in order to manage nuisance. During training, the algorithm learns to match anomaly-crops to the current set of classes. The user can customize the model e.g., include robustness against contrast-variations, account for data imbalance, modify model architecture etc. Optionally, an automatic search for the best model architecture for the given use-case can be manually or automatically performed. During evaluation of the workflow, all anomalies of the current detection of anomalies are input to the model to automatically generate inferred labels.

The objective of the classification step 52 is to maintain the capture rate at a high level, e.g., close to 100%, whereas the nuisance rate should be significantly reduced, e.g., to below 10%.

The classification step 52 can be implemented in the following way:

The input data to this step is a plurality of detected anomalies. If the labeling has not been skipped in the skipping step 60 the anomalies are also labeled for further training. In a first decision step 146 the user decides if he wants to use a pre-trained anomaly classification model (positive answer 148). In this case the user selects a pre-trained model for anomaly classification in a model selection step 152. Then the model is applied to the plurality of anomalies detected by the anomaly detection algorithm in the model application step 154 yielding a current classification of the plurality of anomalies.

If instead the user wants to train or re-train the anomaly classification model based on new sample data (negative answer 150), the user selects a pre-trained anomaly classification model or initializes a new model. In a pre-processing step 156 pre-processing can be applied to the annotated sample data, e.g., data-augmentation, image enhancement or contrast-removal. In a hyper parameter selection step 158 the user selects hyper parameters of the model for training. In a splitting step 160 the training data is split into a set of training data and a set of validation data. The training data is used for training the model in a training step 162, while the validation data is used to monitor the model's performance on unseen data samples in a validation step 164 in order to avoid over adaptation to the training data. Finally, in an analysis step 166 performance metrics are computed.

Based on the classification of the detected anomalies low nuisance rates can be achieved. The reason is that anomalies not containing relevant defects can be assigned to one or more nuisance classes and, thus, do not interfere with the detection of true defects.

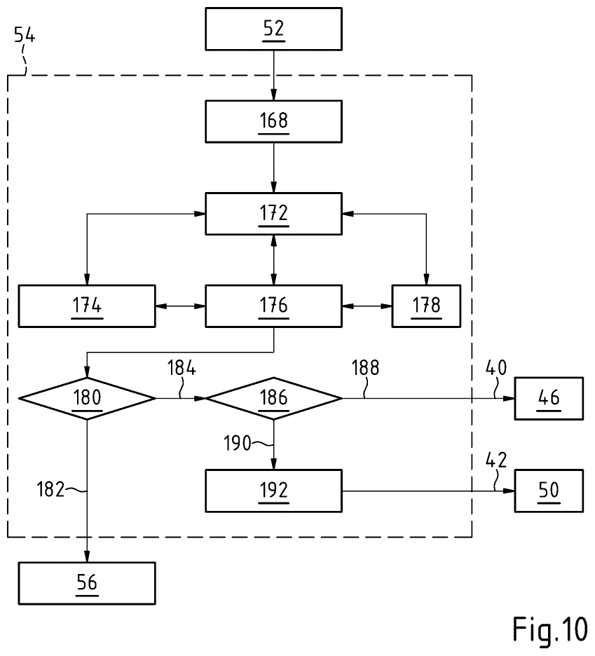

FIG. 10 is a flowchart illustrating an example implementation of the review routine 54.

In this step the user is able to visualize the classification results, which are overlaid on the dataset view. The user can choose which classes to consider, navigate through sFoVs, inspect images by zooming in/out, inspect details of the defects e.g., defect location in global coordinate frame, defect size etc., obtain overall defect statistics, and if available, classification performance metrics e.g., capture rate and nuisance rate.

If the user decides to retrain the classifier due to unsatisfactory classifier performance because of mislabeling or due to false detections during the anomaly detection routine 48, he is directed to a refinement stage for re-training the classifier. In the refinement step, the user can select the size and composition of the dataset to be refined.

An objective of the review process is to increase the user's trust and confidence in the workflow within two or three iterations, after which the review process can be made optional.

Samples annotated by the user in a previous iteration of the workflow will be retained as part of every following training step. Even though the user is not presented again with these samples they are included in the training. If a user adds an additional class to the current set of classes the user is given the opportunity to review and modify previous annotations again.

The review routine 54 can be implemented in the following way:

First, a current classification of the plurality of anomalies based on the current set of classes is determined in a current classification step 168. In a muting step 172 the user can select classes to disregard, i.e., classes which are excluded from the review. This might be the case if the user is confident of some classes and wants to concentrate on the classification results of more difficult classes.

The user can then visualize different types of information for assessing the quality of the trained workflow. In a defect visualization step 174 one or more defect instances can be visualized in the dataset. To this end, the classification results are overlaid on the dataset for analysis. The user can choose which classes to consider, navigate through the scan field of view (sFoV) or inspect images by zooming in or out.

In a metrology step 176 measurements of the defects can be computed, e.g., defect location or defect size. In addition, overall statistics can be computed, e.g., number of defects per class or average defect size. Spatial statistics can be computed based on selected interest-regions 11, e.g., defect density within one or more interest-regions 11. In addition, performance metrics can be computed such as precision, nuisance and capture rate.

In a semantic result step 178 classification results can be evaluated according to steps 174, 176 with respect to semantic masks indicated in the semantic annotation step 74, for example with respect to die regions or border regions only.

Based on the review the user can judge the quality of the detection and classification model and decide on further steps for improving the workflow. In a first decision step 180 the user decides if he is satisfied with the quality of the results. If this is the case (positive answer 182) the workflow continues with the report step 56. Otherwise (negative answer 184), the user decides in a subsequent decision step 186 if the detected anomalies make sense. If this is not the case (negative answer 188) the workflow is repeated by carrying out a further outer iteration 40 starting from the data selection routine 46, so the anomaly detection model can be improved based on further or different data samples. If the detected anomalies make sense (positive answer 190) the anomaly classification algorithm can be improved. To this end, the user selects another or an additional interest-region 11 for refinement of the classification algorithm in a refinement step 192 and goes back to the anomaly classification routine 50 carrying out a further inner iteration 42.

In a subsequent report step 56 the user can save relevant information about the training and/or the model to a file for future reference, e.g., defect-level and dataset-level information, metrology details and statistics. The user can configure the level of detail to be preserved in the report, e.g., crops of defects stored in the report, high-level intensity histograms etc. If available, metrics such as capture rate, nuisance rate and defect source analysis etc. can be included in the report.

The objective of the report step 56 is to capture high-level information of the datasets used to train the model and the underlying defect catalogue. Further, it should be easy for the user to investigate the reasons why a workflow exhibits reduced performance due to shifts in manufacturing or imaging conditions.

FIG. 11 illustrates an implementation of the clustering step 116 in FIG. 8 based on hierarchical clustering. It shows a cluster tree 194 obtained by agglomerative or divisive hierarchical clustering of a set of samples belonging to six different classes: wavy line, start, triangle, square, rectangle, circle. The tree consists of a root cluster 196 at the top, leaf clusters 198, 200, 202 at the bottom and internal clusters 204, 205, 210 in between. The root cluster 196 contains the whole sample set, whereas the leaf clusters 198, 200, 202 contain only a single sample of the sample set.

An agglomerative hierarchical clustering can for example be computed via the hierarchical agglomerative clustering (HAC) algorithm. This method initially assigns each sample to a leaf cluster 198, 200, 202. Based on a similarity measure the similarity between the samples of each two different clusters is computed. For the two clusters with the highest similarity measure a new parent cluster is added to the tree containing the samples from both clusters. For example, the internal clusters 206, 208 both contain similar rectangular structures, i.e. square and rectangle. Therefore, their similarity is high. A new parent cluster 210 is created containing the samples from both child clusters 206, 208. This process is repeated until one cluster contains all samples, which is the root cluster 196.

A divisive hierarchical clustering can be computed via the divisive analysis clustering (DIANA) algorithm (see above). This method initially assigns all samples to the root cluster 196. For each cluster, two child clusters are added to the tree, and the samples contained in the cluster are distributed between these child clusters based on a function. This process is continued until every sample belongs to a separate leaf cluster. The function measures dissimilarities between samples contained in the cluster. The DIANA algorithm determines the sample with the maximum average dissimilarity, adds the sample to one of the child clusters and then moves all samples to this child cluster that are more similar to this child cluster than to the remainder. For example, the cluster 210 is split into two clusters by adding two child clusters 206, 208. The object with the maximum average dissimilarity is one of the rectangles. This is moved to one of the new child clusters, i.e., child cluster 208. Then all objects more similar to this new cluster are moved to this child cluster 208, i.e., the second rectangle is added to the child cluster 208. The remaining samples, that is the squares, are moved to the second new cluster, i.e., the child cluster 206.

FIG. 12 shows an implementation of the annotation step 50′ based on a cluster tree 194. A hierarchical cluster tree based annotation facilitates the annotation of the plurality of anomalies for the user by reducing the number of user interactions. FIG. 12 differs in three aspects from the annotation step 50 in FIG. 8. First, the clustering step 116 is modified to a hierarchical clustering step 116′. Second, the querying step 118 is modified to a hierarchical querying step 118′. Third, the allocation step 136 is modified to a hierarchical allocation step 136′.

In the hierarchical clustering step 116′ a hierarchical clustering method is used to build a cluster tree 194 from the sample data containing the plurality of detected anomalies 15.

In the hierarchical querying step 118′, a cluster of the cluster tree is selected for presentation to the user based on a selection criterion, for example, the cluster with the highest dissimilarity measure compared to the cluster annotated in the previous iteration.

The hierarchical allocation step 136′ allows the user to move through the cluster tree 194 in order to select a desired cluster resolution. If the cluster resolution is too high, samples from possibly many different classes are part of the current cluster. If the cluster resolution is too low, the cluster contains only samples from one class but is very small. In this case, parent clusters higher up in the cluster tree 194 may contain more samples of the same class and thus would can be used for labeling by the user.

The hierarchical allocation step 136′ comprises the following steps: in a decision step 212 the user decides if he is satisfied with the resolution of the current cluster. In this case (positive answer 216) he proceeds with annotating one or more of the samples in the current cluster in the hierarchical annotation step 224 and continues as described above for FIG. 8. Otherwise (negative answer 214), the samples of a larger section of the cluster tree 194 containing the current cluster, e.g., the current cluster, its child clusters and its parent cluster, are displayed by the user interface 236 in a cluster display step 218. The user can inspect the clusters and select one of them in a cluster selection step 220, thereby improving the cluster resolution of the current cluster. The cluster resolution is higher if a child cluster is selected. The cluster resolution is lower if the parent cluster is selected. The process can be repeated in one or more iterations 222 until a satisfying cluster resolution is achieved. Then the current cluster is annotated in the hierarchical annotation step 224.

For example, let the cluster 210 be the cluster selected in the hierarchical querying step 118′. Then the clusters of the child clusters 206, 208 and the cluster of the parent cluster 211 are displayed to the user. The clusters of the child clusters 206, 208 have a higher resolution, only containing samples from a single class, whereas the cluster of the parent cluster 211 contains samples from three different classes and, thus, has a lower resolution. For the user it might be beneficial to move to one of the child clusters 206, 208 and annotate this cluster via a single user interaction.

However, let the cluster 207 be the selected cluster in the hierarchical querying step 118′. Then the clusters of the child clusters 201, 203 and the cluster of the parent cluster 206 are displayed to the user. The clusters of the child clusters 201, 203 have a higher resolution containing only one sample, whereas the cluster of the parent cluster 206 has a lower resolution containing four different samples of the same class. For the user it might be beneficial to move to the parent cluster 206 and annotate this cluster, thereby assigning a label to all four samples instead of only two of them via a single user interaction. The process can be repeated in one or more iterations 222, thereby moving through the clusters of the cluster tree 194, until a satisfying cluster resolution is achieved. Then the current cluster is annotated in the hierarchical annotation step 224. During the annotation of the clusters new classes can be added to the current set of classes in the decision step 128 and the class update step 134.

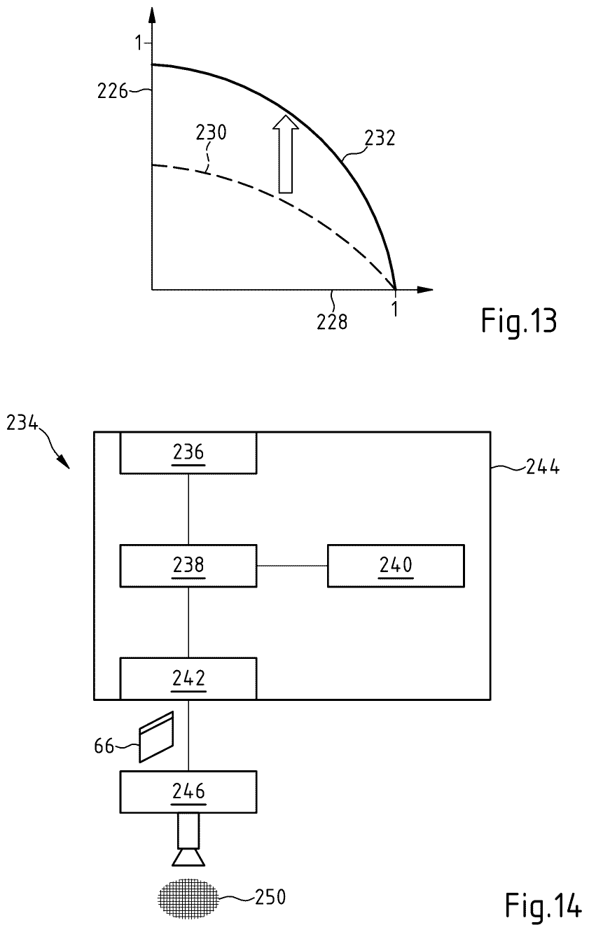

FIG. 13 illustrates an effect of the application of the methods described above. It shows a conventional precision-recall curve 230 and an improved precision-recall curve 232 for defect detection based on the disclosed techniques. The precision axis 226 is the vertical axis and indicates various precision rates. The recall axis 228 is the horizontal axis and indicates various recall rates (i.e. capture rates). Based on conventional anomaly detection methods, the number of detected anomalies is very high, but of these only few are associated with real defects of the wafer 250. Therefore, the number of false positive detections, i.e., nuisance, is high leading to a rather low precision rate of the conventional precision-recall curve 230. By combining anomaly detection and classification, real defects can be discriminated from nuisance, thereby strongly reducing the number of false positive detections. Thus, the precision rate and the recall rate of the improved precision-recall curve 232 are generally higher.

FIG. 14 schematically illustrates a system 234, which can be used for controlling the quality of wafers 250 produced in a semiconductor manufacturing fab. The system 234 includes an imaging device 246 and a processing device 244. The imaging device 246 is coupled to the processing device 244. The imaging device 246 is configured to acquire imaging datasets 66 of the wafer 250. The wafer 250 can include semiconductor structures, e.g., transistors such as field effect transistors, memory cells, et cetera. An example implementation of the imaging device 246 would be a SEM or mSEM, a Helium ion microscope (HIM) or a cross-beam device including FIB and SEM or any charged particle imaging device.

The imaging device 246 can provide an imaging dataset 66 to the processing device 244. The processing device 244 includes a processor 238, e.g., implemented as a CPU or GPU. The processor 238 can receive the imaging dataset 66 via an interface 242. The processor 238 can load program code from a memory 240. The processor 238 can execute the program code. Upon executing the program code, the processor 238 performs techniques such as described herein, e.g., executing an anomaly detection to detect one or more anomalies; training the anomaly detection; executing a classification algorithm to classify the anomalies into a set of classes, e.g., including defect classes, a nuisance class, and/or an unknown class; retraining the ML classification algorithm, e.g., based on an annotation obtained from a user upon presenting at least one anomaly to the user, e.g., via the respective user interface 236, computing a cluster tree 194 based on a hierarchical clustering method, assessing the quality of the wafer 250. For example, the processor 238 can perform the computer implemented methods 28 or 28′ shown in FIG. 4 or FIG. 5 respectively upon loading program code from the memory 240.

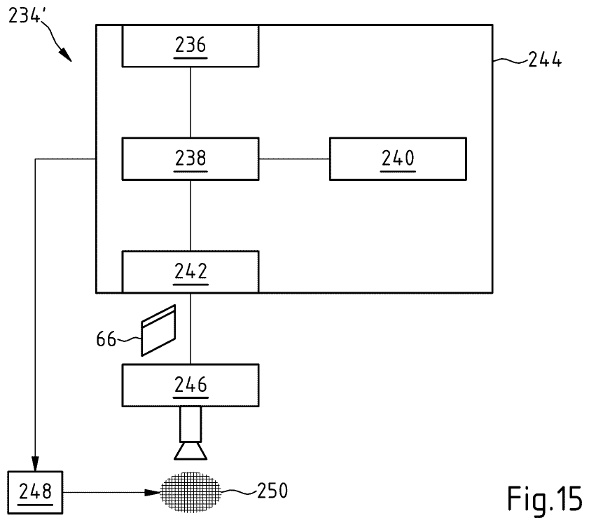

FIG. 15 schematically illustrates a system 234′, which can be used for controlling the production of wafers 250 in a semiconductor manufacturing fab. The system comprises the same components as indicated in FIG. 14 and the above also applies for the respective components here. In addition, the system 234′ has a mechanism 248 for producing wafers 250 controlled by at least one wafer manufacturing process parameter. To this end, an imaging dataset 66 is provided to the processing device via the imaging device 246. The processor 238 of the processing device 244 is configured to perform one of the disclosed methods comprising controlling the at least one wafer manufacturing process parameter based on one or more measurements of the current classification of anomalies in the imaging dataset of the wafer 250. For example, detected bridge defects indicate insufficient etching, so the amount of etching is increased, detected line breaks indicate excessive etching, so the amount of etching is decreased, consistently occurring defects indicate a defective mask, so the mask is checked, and detected missing structures hint at non-ideal material deposition, so the material deposition is modified.

U.S. patent application Ser. No. 17/376,664, filed Jul. 15, 2021, is hereby incorporated by reference in its entirety.

Embodiments, examples and aspects of the disclosure can be described by the following clauses:
1. A computer implemented method (28, 28′) for the detection and classification of anomalies (15) in an imaging dataset (66) of a wafer comprising a plurality of semiconductor structures, the method comprising:
Selecting a machine learning anomaly classification algorithm;
Executing at least one outer iteration (40) comprising the following steps:
   i. Determining a current detection of a plurality of anomalies (15) in the imaging dataset (66);
   ii. Executing multiple inner iterations (42), at least some of them comprising the following steps:
      a. Using the anomaly classification algorithm to determine a current classification of the plurality of anomalies (15) in the imaging dataset (66);
      b. Based on at least one decision criterion selecting at least one anomaly (15) of the current detection of the plurality of anomalies (15) for presentation to a user via a user interface (236), the user interface (236) being configured to let the user assign a class label of a current set of classes to each of the at least one anomaly (15);
      c. Re-training the anomaly classification algorithm based on anomalies (15) annotated by the user in an inner iteration (42) of the current or any previous outer iteration (40).
2. The method of clause 1, wherein multiple outer iterations (40) are executed, at least some of them comprising steps i. and ii.
3. The method of clause 1 or 2, wherein determining a current detection of a plurality of anomalies (15) in the imaging dataset (66) in step i. comprises:
selecting a machine learning anomaly detection algorithm;
training the anomaly detection algorithm;
determining a current detection of a plurality of anomalies (15) in the imaging dataset (66).
4. The method of clause 3, wherein the training of the anomaly detection algorithm comprises at least one intermediate iteration (44) comprising the following steps:
selecting training data for the anomaly detection algorithm, the training data containing at least one subset of the imaging dataset (66) of the wafer and/or of an imaging dataset (66) of at least one other wafer and/or of an imaging dataset (66) of a wafer model;
re-training the anomaly detection algorithm based on training data selected in an intermediate iteration (44) of the current or any previous outer iteration (40).
5. The method of clause 4, wherein the user interface (236) is configured to let the user define one or more interest-regions (11) in the imaging dataset (66), and the training data for the anomaly detection algorithm is selected only based on the interest-regions (11).
6. The method of clause 4 or 5, wherein the user interface (236) is configured to let the user define one or more exclusion-regions in the imaging dataset (66), and the training data for the anomaly detection algorithm does not contain data based on the exclusion-regions.
7. The method of any one of clauses 3 to 6, wherein the anomaly detection algorithm comprises an autoencoder neural network, and the plurality of anomalies (15) are detected based on a comparison between an input tile of the imaging dataset (66) and a reconstructed representation thereof obtained by presenting the tile to the autoencoder neural network, the tile containing an anomaly (15) and a surrounding of the anomaly (15).
8. The method of any one of clauses 1 to 7, wherein each anomaly (15) is associated with a feature vector, and the decision criterion is formulated with regard to the feature vectors associated with the plurality of anomalies (15).
9. The method of clause 8, wherein the feature vector associated with an anomaly (15) comprises the raw imaging data or pre-processed imaging data of the anomaly (15) or of a tile containing the anomaly (15).
10. The method of clause 8 or 9, wherein the feature vector associated with an anomaly (15) comprises the activation of a layer of a pre-trained neural network when presented with the anomaly (15) as input.
11. The method of one of clauses 8 to 10, wherein the feature vector associated with an anomaly (15) comprises a histogram of oriented gradients of the anomaly (15).
12. The method of any one of clauses 1 to 11, wherein multiple anomalies (15) are selected for presentation to the user, and the at least one decision criterion comprises a similarity measure between the multiple anomalies (15).
13. The method of clause 12, further comprising selecting the multiple anomalies (15) to have a high similarity measure between each other.
14. The method of any one of clauses 1 to 13, wherein the at least one decision criterion comprises a similarity measure of the selected at least one anomaly (15) and one or more further anomalies (15) that were selected in one or more previous iterations in step ii.b.
15. The method of clause 14, further comprising selecting the multiple anomalies (15) to have a low similarity measure with respect to the one or more further anomalies (15) that were selected in the one or more previous iterations in step ii.b.
16. The method of any one of clauses 1 to 15, wherein the at least one decision criterion comprises a probability of an anomaly (15) for not belonging to the current set of classes.
17. The method of clause 16, wherein the anomaly classification algorithm is an open set classifier and the probability of the anomaly (15) for not belonging to the current set of classes is estimated by the open set classifier.
18. The method of any one of clauses 1 to 17, wherein the at least one decision criterion comprises the selected at least one anomaly (15) being classified as a predefined class or a class from a predefined set of classes in the current classification.
19. The method of any one of clauses 1 to 18, wherein multiple anomalies (15) are selected for presentation to the user, and the at least one decision criterion comprises the multiple anomalies (15) being classified as the same class in the current anomaly classification.
20. The method of any one of clauses 1 to 19, wherein the at least one decision criterion comprises a population of the one or more classes the at least one anomaly (15) is assigned to in the current classification.
21. The method of any one of clauses 1 to 20, wherein multiple anomalies (15) are concurrently presented to the user, and the method further comprises grouping and/or sorting the multiple anomalies (15) for presentation to the user.
22. The method of any one of clauses 1 to 21, wherein the at least one decision criterion comprises a context of the selected at least one anomaly (15) with respect to the semiconductor structures.
23. The method of any one of clauses 1 to 22, wherein the at least one decision criterion implements at least one member selected from the group consisting of an explorative annotation scheme and an exploitative annotation scheme.
24. The method of any one of clauses 1 to 23, wherein the at least one decision criterion differs for at least two iterations of the inner iterations (42).
25. The method of any one of clauses 1 to 24, the decision criterion further comprising selecting the at least one anomaly (15) based on an unsupervised or semi-supervised clustering of the detected plurality of anomalies (15).
26. The method of clause 25, wherein the unsupervised clustering is based on a hierarchical clustering method used to compute a cluster tree (194), wherein the root cluster (196) contains the detected plurality of anomalies (15), each leaf cluster (198, 200, 202) contains a single anomaly (15) of the detected plurality of anomalies (15) and for all internal clusters (204, 205) of the tree the following applies: for an internal cluster (204, 205) with n child clusters i={1, . . . , n} let aᵢ, i ∈ {1, . . . , n} indicate the set of anomalies (15) of child cluster i, then {a₁, . . . , aₙ} is a partition of the set of anomalies (15) contained in the internal cluster (204, 205).
27. The method of clause 26, wherein the hierarchical clustering method comprises an agglomerative clustering method, where two clusters (201, 203, 206) are merged, starting from the leaves of the cluster tree (194), based on a cluster distance measure.
28. The method of clause 27, wherein the cluster distance measure comprises a function of pairwise distances, each between an anomaly (15) of the first and an anomaly (15) of the second cluster (201, 203, 206) of the two clusters (201, 203, 206).
29. The method any one of clauses 27 to 30, wherein the function used for computing the cluster distance measure is Ward's minimum variance method.
30. The method of clause 26, wherein the hierarchical clustering method comprises a divisive clustering method, where a cluster (201, 203, 206) is iteratively split, starting from the root cluster (196) of the cluster tree (194), based on a dissimilarity measure between the anomalies (15) contained in the cluster (201, 203, 206).
31. The method of any one of clauses 26 to 30, wherein the decision criterion comprises selecting a cluster (201, 203, 206) of the cluster tree (194) for presentation to the user.
32. The method of clause 31, the user interface (236) being configured to allow the user to select a cluster (201, 203, 206) suitable for annotation by iteratively moving from the current cluster (201, 203, 206) to its parent cluster or to one of its child clusters (201, 203, 206) in the cluster tree (194).
33. The method of clause 31, wherein the user interface (236) is configured to display a section of the cluster tree (194) containing the currently selected cluster (201, 203, 206) and to let the user select one of the displayed clusters (201, 203, 206) of the section of the cluster tree (194) for annotation.
34. The method of any one of clauses 1 to 33, wherein multiple anomalies (15) are concurrently presented to the user and the user interface (236) is configured to batch annotate the multiple anomalies (15).
35. The method of clause 34, wherein batch annotation of the multiple anomalies (15) comprises batch assigning of a plurality of labels to the multiple anomalies (15) concurrently presented to the user.
36. The method of any one of clauses 1 to 35, wherein the current set of classes is initialized as a predefined set of classes.
37. The method of any one of clauses 1 to 36, wherein the annotation of the at least one anomaly (15) in step ii.b. comprises the option to add a new class to the current set of classes.
38. The method of clause 37, further comprising, upon adding a new class to the current set of classes, offering the user an option to assign previously labeled training data to the new class.
39. The method of clause 37 or 38, wherein the anomaly classification algorithm comprises an open set classifier.
40. The method of any one of clauses 1 to 39, wherein the current set of classes is organized hierarchically and this knowledge is included in the training of the anomaly classification algorithm.
41. The method of any one of clauses 1 to 40, wherein the current set of classes contains at least one defect class and at least one nuisance class.
42. The method of any one of clauses 1 to 41, wherein the current set of classes contains an unknown anomaly class.
43. The method of any one of clauses 1 to 42, wherein the selection of a machine learning algorithm comprises selecting one or more of the following attributes:
a model architecture;
an optimization algorithm for carrying out the training;
hyperparameters of the model and the optimization algorithm;
an initialization of the parameters of the model;
pre-processing techniques of the training data.
44. The method of clause 43, wherein one or more attributes of the machine learning algorithm are selected based on specific application knowledge.
45. The method of clause 43 or 44, the at least one outer iteration further comprising a modification step (90) containing an option to modify one or more attributes of the machine learning algorithm.
46. The method of any one of clauses 1 to 45, wherein the imaging dataset (66) is a multibeam SEM image.
47. The method of any one of clauses 1 to 46, wherein the imaging dataset (66) is a focused ion beam SEM image.
48. The method of any one of clauses 1 to 47, further comprising determining one or more measurements based on the current classification of the plurality of anomalies (15).
49. The method of clause 48, wherein the user interface is configured to let the user define one or more interest-regions (11) in the imaging dataset (66), especially die regions or border regions, and wherein the one or more measurements are computed based on the current classification of the plurality of anomalies (15) within each of the one or more interest-regions (11) separately.
50. The method of clause 49, further comprising automatically suggesting one or more new interest-regions (11) based on at least one selection criterion and presenting the suggested one or more interest-regions (11) to the user via the user interface (236).
51. The method of any one of clauses 48 to 50, wherein the one or more measurements are selected from the group containing anomaly size, anomaly area, anomaly location, anomaly aspect ratio, anomaly morphology, number or ratio of anomalies, anomaly density, anomaly distribution, moments of an anomaly distribution, performance metrics, precision, recall, nuisance rate.
52. The method of clause 51, wherein the one or more measurements are selected from the group for a specific defect or a specific set of defects.
53. The method of any one of clauses 48 to 52, further comprising controlling at least one wafer manufacturing process parameter based on the one or more measurements.
54. The method of any one of clauses 48 to 53, further comprising assessing the quality of the wafer based on the one or more measurements and at least one quality assessment rule.
55. One or more machine-readable hardware storage devices comprising instructions that are executable by one or more processing devices (244) to perform operations comprising the method of any one of clauses 1 to 54.
56. A system (234) for controlling the quality of wafers produced in a semiconductor manufacturing fab, the system comprising
an imaging device (246) adapted to provide an imaging dataset (66) of the wafer;
a graphical user interface (236) configured to present data to the user and obtain input data from the user;
one or more processing devices (244);
one or more machine-readable hardware storage devices comprising instructions that are executable by one or more processing devices (244) to perform operations comprising the method of clause 54.
57. A system (234′) for controlling the production of wafers in a semiconductor manufacturing fab, the system comprising
a mechanism (248) for producing wafers (250) controlled by at least one manufacturing process parameters;
an imaging device (246) adapted to provide an imaging dataset (66) of the wafers;
a graphical user interface (236) configured to present data to the user and obtain input data from the user;
one or more processing devices (244);
   one or more machine-readable hardware storage devices comprising instructions that are executable by one or more processing devices (244) to perform operations comprising the method of clause 53.

In summary, the disclosure relates to a computer implemented method 28, 28′ for the detection and classification of anomalies 15 in an imaging dataset 66 of a wafer comprising a plurality of semiconductor structures. The method comprises determining a current detection of a plurality of anomalies 15 in the imaging dataset 66 and obtaining an unsupervised or semi-supervised clustering of the current detection of the plurality of anomalies 15. Based on at least one decision criterion at least one cluster of the clustering is selected for presentation and annotation to a user via a user interface 236. An anomaly classification algorithm is re-trained based on the annotated anomalies 15. A system 234 for controlling the quality of wafers and a system 234′ for controlling the production of wafers are also disclosed.

Reference number list

| | |
|---|---|
| 10 | cell structure |
| 11 | interest-region |
| 12 | cell |
| 14 | defective cell structure |
| 15 | anomaly |
| 16 | open |
| 18 | puncture |
| 20 | merge |
| 22 | half-open |
| 24 | dwarf |
| 26 | skid |
| 28, 28′ | computer implemented method |
| 30 | data selection routine |
| 32 | anomaly detection routine |
| 34 | anomaly classification routine |
| 36 | annotation routine |
| 38 | re-training routine |
| 40 | outer iteration |
| 42 | inner iteration |
| 44 | Intermediate iteration |
| 46 | data selection routine |
| 48 | anomaly detection routine |
| 50, 50′ | annotation routine |
| 52 | anomaly classification routine |
| 54 | review routine |
| 56 | report step |
| 60 | skipping step |
| 66 | imaging dataset |
| 68 | decision step |
| 70 | positive answer |
| 72 | negative answer |
| 74 | semantic annotation step |
| 76 | regulatory annotation step |
| 78 | decision step |
| 80 | positive answer |
| 82 | model selection step |
| 84 | model application step |
| 86 | current detection step |
| 88 | negative answer |
| 90 | modification step |
| 92 | analysis step |
| 94 | decision step |
| 96 | negative answer |
| 98 | decision step |
| 100 | positive answer |
| 102 | negative answer |
| 104 | positive answer |
| 106 | threshold selection step |
| 108 | saving step |
| 110 | decision step |
| 112 | negative answer |
| 114 | positive answer |
| 116 | clustering step |
| 116′ | hierarchical clustering step |
| 118 | querying step |
| 118′ | hierarchical querying step |
| 120 | decision step |
| 122 | positive answer |
| 124 | negative answer |
| 126 | visualization step |
| 128 | decision step |
| 130 | positive answer |
| 132 | negative answer |
| 134 | class update step |
| 136 | allocation step |
| 136′ | hierarchical allocation step |
| 138 | decision step |
| 140 | positive answer |
| 142 | negative answer |
| 144 | saving step |
| 146 | decision step |
| 148 | positive answer |
| 150 | negative answer |
| 152 | model selection step |
| 154 | model application step |
| 156 | pre-processing step |
| 158 | hyper parameter selection step |
| 160 | splitting step |
| 162 | training step |
| 164 | inference step |
| 166 | analysis step |
| 168 | current classification step |
| 172 | muting step |
| 174 | defect visualization step |
| 176 | metrology visualization step |
| 178 | semantic result step |
| 180 | decision step |
| 182 | positive answer |
| 184 | negative answer |
| 186 | decision step |
| 188 | negative answer |
| 190 | positive answer |
| 192 | refinement step |
| 194 | cluster tree |
| 196 | root cluster |
| 198, 200, 202 | leaf cluster |
| 204, 205 | internal cluster |
| 201, 203, 206, 207, 208, 210, 211 | cluster |
| 212 | decision step |
| 214 | negative answer |
| 216 | positive answer |
| 218 | cluster display step |
| 220 | cluster selection step |
| 222 | iteration |
| 224 | hierarchical annotation step |
| 226 | precision axis |
| 228 | recall axis |
| 230 | conventional precision-recall curve |
| 232 | improved prevision-recall curve |
| 234, 234′ | system |
| 236 | user interface |
| 238 | CPU |
| 240 | memory |
| 242 | interface |
| 244 | processing device |
| 246 | imaging device |
| 248 | mechanism |
| 250 | wafer |

1. A computer implemented method, comprising:
selecting a machine learning anomaly classification algorithm;
executing at least one outer iteration comprising:
i) determining a current detection of a plurality of anomalies in an imaging dataset of a wafer, the wafer comprising a plurality of semiconductor structures;
ii) obtaining an unsupervised or semi-supervised clustering of the current detection of the plurality of anomalies;
iii) executing multiple inner iterations, at least some of the inner iterations comprising:
a) using the anomaly classification algorithm to determine a current classification of the plurality of anomalies in the imaging dataset;
b) based on at least one decision criterion, selecting at least one anomaly of the current detection of the plurality of anomalies by selecting at least one cluster of the clustering for presentation to a user via a user interface configured to allow the user to assign one or more class labels of a current set of classes to each of the at least one cluster; and
c) re-training the anomaly classification algorithm based on anomalies annotated by the user in an inner iteration of the current or any previous outer iteration,
detecting and classifying anomalies in the imaging dataset of the wafer based on i)-iii).

2. The method of claim 1, wherein the outer iteration is executed a plurality of times.

3. The method of claim 1, wherein i) comprises:
selecting a machine learning anomaly detection algorithm; and
determining a current detection of a plurality of anomalies in the imaging dataset.

4. The method of claim 1, wherein each anomaly is associated with a feature vector, and the decision criterion is formulated with regard to the feature vectors associated with the plurality of anomalies.

5. The method of claim 1, wherein b) comprises selecting multiple anomalies for presentation to the user, and the at least one decision criterion comprises a similarity measure between the multiple anomalies.

6. The method of claim 1, wherein the at least one decision criterion comprises:
a similarity measure of the selected at least one anomaly, and one or more further anomalies that were selected in one or more previous iterations during b);
a probability of an anomaly for not belonging to the current set of classes;
the selected at least one anomaly being classified as a predefined class or a class from a predefined set of classes in the current classification; or
a population of the one or more classes the at least one anomaly is assigned to in the current classification.

7. The method of claim 1, wherein multiple anomalies are selected for presentation to the user, and the at least one decision criterion comprises the multiple anomalies being classified as the same class in the current anomaly classification.

8. The method of claim 1, wherein multiple anomalies are concurrently presented to the user, and the method further comprises grouping and/or sorting the multiple anomalies for presentation to the user.

9. The method of claim 1, wherein the at least one decision criterion comprises a context of the selected at least one anomaly with respect to the semiconductor structures.

10. The method of claim 1, wherein the at least one decision criterion implements at least one member selected from the group consisting of an explorative annotation scheme and an exploitative annotation scheme.

11. The method of claim 1, wherein the at least one decision criterion differs for at least two iterations of the inner iterations.

12. The method of claim 1, wherein one of the at least one decision criterion comprises selecting a cluster for presentation to the user according to:
a group novelty measure, such that the selected cluster is most dissimilar to one or more of the previously selected clusters;
a between group similarity measure, which measures the similarity between the selected cluster and one or more of the previously presented clusters; or
a between group dissimilarity measure, which measures the dissimilarity between the selected cluster and one or more of the previously presented clusters.

13. The method according to claim 1, wherein the user interface is configured to present multiple clusters to the user to allow the user select one or more of the presented multiple clusters and to let the user assign one or more class labels of a current set of classes to the selected clusters.

14. The method according to claim 1, wherein ii) takes into account the current detection of anomalies and/or the current classification of anomalies of one or more previous outer or inner iterations.

15. The method according to claim 1, wherein the at least one decision criterion comprises selecting a cluster for presentation to the user according to the size of the cluster and/or according to the distribution of the anomalies within the cluster.

16. The method of claim 1, wherein:
the unsupervised or semi-supervised clustering is based on a hierarchical clustering method used to compute a cluster tree;
a root cluster comprises the detected plurality of anomalies;
each leaf cluster comprises a single anomaly of the detected plurality of anomalies; and
for all internal clusters of the tree, for an internal cluster with n child clusters i={1, . . . , n}, aᵢ, i ∈ {1, . . . , n} indicate the set of anomalies of child cluster i, and {a₁, . . . , aₙ} is a partition of the set of anomalies contained in the internal cluster.

17. The method of claim 1, wherein multiple anomalies are concurrently presented to the user, and the user interface is configured to batch annotate the multiple anomalies.

18. The method of claim 1, wherein the current set of classes is initialized as a predefined set of classes.

19. The method of claim 1, wherein b) comprises adding a new class to the current set of classes.

20. The method of claim 1, wherein the current set of classes is organized hierarchically, and this information is included in the training of the anomaly classification algorithm.

21.-34. (canceled)

35. One or more machine-readable hardware storage devices comprising
instructions that are executable by one or more processing devices to perform operations
comprising the method of claim 1.

36. A system comprising:
one or more processing devices; and
one or more machine-readable hardware storage devices comprising instructions that are executable by the one or more processing devices to perform operations comprising the method of claim 1.

37. (canceled)

38. (canceled)
